(19) United States
(12) Patent Application Publication
(10) Pub. No.: US 2025/0097955 A1
(43) Pub. Date: Mar. 20, 2025

(54) METHODS, DEVICES AND COMPUTER STORAGE MEDIA FOR COMMUNICATION

(71) Applicant: NEC COPORATION, Tokyo (JP)

(72) Inventors: Peng GUAN, Beijing (CN); Yukai GAO, Beijing (CN); Gang WANG, Beijing (CN)

(73) Assignee: NEC CORPORATION, Tokyo (JP)

(21) Appl. No.: 18/730,555

(22) PCT Filed: Jan. 25, 2022
(86) PCT No.: PCT/CN2022/073882

§ 371 Date: Jul. 19, 2024

(51) Int. Cl. H04W 72/231; H04B 7/06; H04L 5/00; H04W 76/20

(52) U.S. Cl. CPC H04W 72/231; H04B 7/0639; H04L 5/0051; H04W 76/20

(57) ABSTRACT

Embodiments of the present disclosure relate to a method, device and computer readable storage medium of communication. The method comprises receiving, at a terminal device deployed with a plurality of sets of antenna ports, a downlink control information (DCI) message for scheduling at least one uplink transmission over at least two of the plurality of sets of antenna ports, the DCI message indicating: first information about sounding reference signal (SRS) resources associated with the at least one uplink transmission, second information about the precoding information associated with the at least one uplink transmission and third information indicating a transmission mode of the at least one uplink transmission; and transmitting, based on the DCI message, the at least one uplink transmission over the at least two of the plurality of sets of antenna ports to a network. In this way, a simultaneous transmission across multi-panels is well supported.

### FIELD

Example embodiments of the present disclosure generally relate to the field of communication techniques and in particular, to methods, devices, and medium for simultaneous transmission across multi-panels (StxMP).

### BACKGROUND

A codebook-based (CB-based) physical uplink shared channel transmission (PUSCH) transmission is a traditional uplink transmission scheme. When scheduling the CB-based PUSCH transmission, a network device may determine and indicate a transmit precoding matrix index (TPMI) to the terminal device (such as, a user equipment, UE), based on sounding reference signal (SRS) measurements and a predefined codebook. Further, it is proposed that a terminal device may be deployed with more than one panel. As a traditional assumption, the terminal device can transmit with only one panel at a time even if the terminal device is equipped with multiple panels.

In order to improve the transmission performance, a technology of STxMP is expected to be supported. Although some discussions for the STxMP have been made, there are still a plurality of pending issues needed to be discussed, such that a CB-based PUSCH STxMP may be better supported.

### SUMMARY

In general, example embodiments of the present disclosure provide methods, devices and computer storage media for communication.

In a first aspect, there is provided a method of communication. The method comprises: receiving, at a terminal device deployed with a plurality of sets of antenna ports, a downlink control information (DCI) message for scheduling at least one uplink transmission over at least two of the plurality of sets of antenna ports, the DCI message indicating: first information about SRS resources associated with the at least one uplink transmission, second information about the precoding information associated with the at least one uplink transmission; and third information indicating a transmission mode of the at least one uplink transmission; and transmitting, based on the DCI message, the at least one uplink transmission over the at least two of the plurality of sets of antenna ports to a network.

In a second aspect, there is provided a method of communication. The method comprises: transmitting, at a terminal device and to a network, full power transmission capability information indicating: a panel-level full power transmission capability, and a port-level full power transmission capability within a panel; receiving, a configuration for at least one uplink transmission from the network, the configuration indicating a TPMI or TPMI combination; and controlling, a transmit power of the at least one uplink transmission based on the full power transmission capability information and the indicated TPMI or TPMI combination.

In a third aspect, there is provided a method of communication. The method comprises: receiving, at a terminal device and from a network device, transmission information comprising: first waveform information to be used by the terminal device for performing at least one uplink transmission, the first waveform information being comprised in a DCI message or a media-access-control control element (MAC CE) message, second waveform information used by the terminal device when performing a latest SRS transmission, and precoding information to be used by the terminal device for performing the at least one uplink transmission; and determining a TPMI or TPMI combination based on the transmission information.

In a fourth aspect, there is provided a method of communication. The method comprises: transmitting, at a network device and to a terminal device deployed with a plurality of sets of antenna ports, a DCI message for scheduling at least one uplink transmission over at least two of the plurality of sets of antenna ports, the DCI message indicating: first information about SRS resources associated with the at least one uplink transmission, second information about the precoding information associated with the at least one uplink transmission; and third information indicating a transmission mode of the at least one uplink transmission; and receiving, based on the DCI message, the at least one uplink transmission transmitted over the at least two of the plurality of sets of antenna ports from the terminal device.

In a fifth aspect, there is provided a method of communication. The method comprises: receiving, at a network device and from a terminal device, transmission information comprising: first waveform information to be used by the terminal device for performing at least one uplink transmission, the first waveform information being comprised in a DCI message or a MAC CE message, second waveform information used by the terminal device when performing a latest SRS transmission, and precoding information to be used by the terminal device for performing at least one uplink transmission; and determining a TPMI or TPMI combination based on the transmission information.

In a sixth aspect, there is provided a terminal device. The terminal device comprises circuitry configured to perform the method according to the above first aspect of the present disclosure.

In a seventh aspect, there is provided terminal device. The terminal device comprises circuitry configured to perform the method according to the above second aspect of the present disclosure.

In an eighth aspect, there is provided terminal device. The terminal device comprises circuitry configured to perform the method according to the above third aspect of the present disclosure.

In a ninth aspect, there is provided network device. The network device comprises circuitry configured to perform the method according to the above fourth aspect of the present disclosure.

In a tenth aspect, there is provided network device. The network device comprises circuitry configured to perform the method according to the above fifth aspect of the present disclosure.

In an eleventh aspect, there is provided a computer readable medium having instructions stored thereon. The instructions, when executed on at least one processor, causing the at least one processor to perform the method according to any of the above first to fifth aspects of the present disclosure.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1A illustrates a signaling flow for scheduling a CB-based PUSCH transmission in the related solution;

FIG. 1B illustrates examples of coherent types in the related solution;

FIG. 1C illustrates examples of full power modes in the related solution;

FIGS. 2A to 2C illustrate example communication networks in which embodiments of the present disclosure can be implemented;

FIG. 3 illustrates a signaling flow for communication according to some example embodiments of the present disclosure;

FIGS. 4A to 4C illustrate examples of different transmission mode;

FIGS. 5A to 5D illustrate examples of different transmission mode;

FIG. 6 illustrates examples for controlling transmit power;

FIG. 7 illustrates a timing where the TPMI or TPMI combination based on the first waveform information and the precoding information indicated by the DCI message;

FIG. 8 illustrates a timing where the TPMI or TPMI combination based on the precoding information indicated by the DCI message and the second waveform information.

FIG. 9 illustrates a timing the TPMI or TPMI combination based on first waveform information is indicated by a MEC CE message.

FIG. 10 illustrates a flowchart of an example method performed by a terminal device in accordance with some embodiments of the present disclosure;

FIG. 11 illustrates a flowchart of an example method performed by a terminal device in accordance with some embodiments of the present disclosure;

FIG. 12 illustrates a flowchart of an example method performed by a terminal device in accordance with some embodiments of the present disclosure;

FIG. 13 illustrates a flowchart of an example method performed by a network device in accordance with some embodiments of the present disclosure;

FIG. 14 illustrates a flowchart of an example method performed by a network device in accordance with some embodiments of the present disclosure; and

FIG. 15 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

In some examples, values, procedures, or apparatus are referred to as “best,” “lowest,” “highest,” “minimum,” “maximum,” or the like. It will be appreciated that such descriptions are intended to indicate that a selection among many used functional alternatives can be made, and such selections need not be better, smaller, higher, or otherwise preferable to other selections.

As used herein, the term “network device” refers to a device which is capable of providing or hosting a cell or coverage where terminal devices can communicate. Examples of a network device include, but not limited to, a Node B (NodeB or NB), an Evolved NodeB (eNodeB or eNB), a NodeB in new radio access (gNB) a Remote Radio Unit (RRU), a radio head (RH), a remote radio head (RRH), a low power node such as a femto node, a pico node, a statellite network device, an aircraft network device, and the like. For the purpose of discussion, in the following, some example embodiments will be described with reference to eNB as examples of the network device.

As used herein, the term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

Although functionalities described herein can be performed, in various example embodiments, in a fixed and/or a wireless network node may, in other example embodiments, functionalities may be implemented in a user equipment apparatus (such as a cell phone or tablet computer or laptop computer or desktop computer or mobile IoT device or fixed IoT device). This user equipment apparatus can, for example, be furnished with corresponding capabilities as described in connection with the fixed and/or the wireless network node(s), as appropriate. The user equipment apparatus may be the user equipment and/or or a control device, such as a chipset or processor, configured to control the user equipment when installed therein. Examples of such functionalities include the bootstrapping server function and/or the home subscriber server, which may be implemented in the user equipment apparatus by providing the user equipment apparatus with software configured to cause the user equipment apparatus to perform from the point of view of these functions/nodes.

A wireless communication network comprises at least one network device and at least one terminal device. Further, the terminal device may transmit an uplink transmission (such as, a PUSCH transmission) to the network device.

As discussed previously, the CB-based PUSCH transmission is a traditional uplink transmission scheme. During the CB-based PUSCH transmission, the block of vectors [y⁽⁰⁾(i) . . . y^{(v-1)}(i)]^{T}, where i=0, 1, . . . , M_{symb}^{layer}−1 and M_{symb}^{ap}=M_{symb}^{layer} shall be precoded according to below Equation (1).

$$[ \begin{matrix}{z}^{( {p}_{0} )} ( i ) \\ ⋮ \\ {z}^{( {p}_{ρ - 1} )} ( i )\end{matrix} ] = W [ \begin{matrix}{y}^{( 0 )} ( i ) \\ ⋮ \\ {y}^{( υ - 1 )} ( i )\end{matrix} ] \qquad Equation ( 1 )$$

where {p₀, . . . . p_{ρ-1}} refers to a set of antenna ports, W refers to a precoding matrix. Further, for single-layer transmission on a single antenna port, W=1, otherwise, W is indicated by a DCI message for scheduling the CB-based PUSCH transmission according to a predefined codebook.

Below Table 1 is an example of a codebook for four-layer transmission using four antenna ports with transform precoding disabled.

TABLE 1
example of the codebook

| TPMI | W | | | |
|---|---|---|---|---|
| index | (ordered from left to right in increasing order of TPMI index) | | | |
| 0-3 | $\frac{1}{2} [ \begin{matrix}1 & 0 & 0 & 0 \\ 0 & 1 & 0 & 0 \\ 0 & 0 & 1 & 0 \\ 0 & 0 & 0 & 1\end{matrix} ]$ | $\frac{1}{2 \sqrt{2}} [ \begin{matrix}1 & 1 & 0 & 0 \\ 0 & 0 & 1 & 1 \\ 1 & - 1 & 0 & 0 \\ 0 & 0 & 1 & - 1\end{matrix} ]$ | $\frac{1}{2 \sqrt{2}} [ \begin{matrix}1 & 1 & 0 & 0 \\ 0 & 0 & 1 & 1 \\ j & - j & 0 & 0 \\ 0 & 0 & j & - j\end{matrix} ]$ | $\frac{1}{4} [ \begin{matrix}1 & 1 & 1 & 1 \\ 1 & - 1 & 1 & - 1 \\ 1 & 1 & - 1 & - 1 \\ 1 & - 1 & - 1 & 1\end{matrix} ]$ |
| 4 | $\frac{1}{4} [ \begin{matrix}1 & 1 & 1 & 1 \\ 1 & - 1 & 1 & - 1 \\ j & j & - j & - j \\ j & - j & - j & j\end{matrix} ]$ | — | — | — |

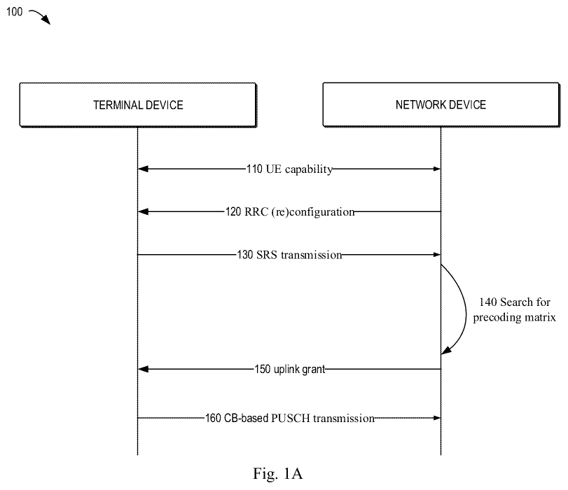

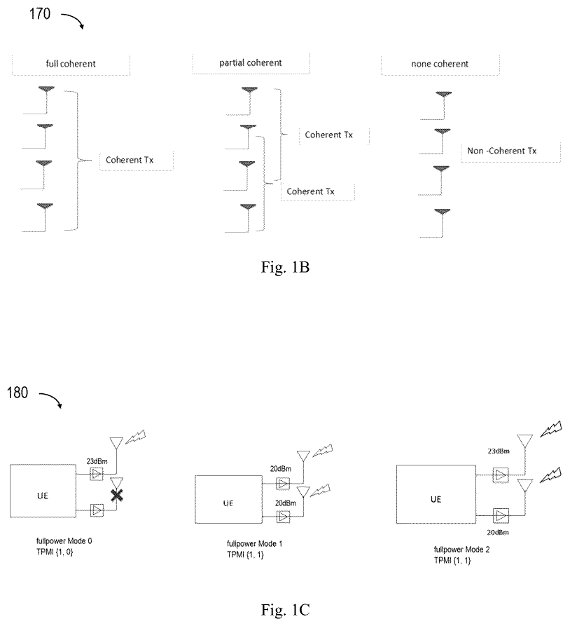

Reference is now made to FIG. 1A, which illustrates a signaling flow 100 for CB-based PUSCH. As illustrated in FIG. 1A, the terminal device and the network device may transfer 110 information about UE capability with each other.

One example of the UE capability is the coherent type(s) supported by the terminal device, where the coherent type may be one of full coherent (fullCoherent), partial coherent (partialCoherent) and Non-coherent (nonCoherent). In one specific example embodiment, the coherent type(s) may be reported by using an information element (IE) pusch-TransCoherence. FIG. 1B illustrates examples 170 of coherent type in the related solution. In addition, only a subset of precoders can be used for a certain coherence type.

Another example of the UE capability is the full power mode(s) supported by the terminal device, where the full power mode may be one of fullpower mode 0 (fullpower or ul-FullPwrMode), fullpower mode 1 (ul-FullPwrMode1 or fullpowerMode1) and fullpower mode 2 (ul-FullPwrMode2 or fullpowerMode2). FIG. 1C illustrates examples 180 of full power mode in the related solution. Specifically, in case of fullpower mode 0, the transmit power is equally split among non-zero PUSCH antenna(s) thereby enabling the terminal device to deliver the maximum output power of 23 dBm. In case of fullpower mode 1, the terminal device can transmit with the total maximum output power of 23 dBm on PUSCH with precoder {1, 1}, which means that the precoders {1, 0} and {0, 1} cannot deliver the maximum output power. In case of fullpower mode 2, the terminal device can transmit with the total maximum output power of 23 dBm on PUSCH with precoder {1, 1} through procedures of the TPMI reporting and antenna virtualization.

Further, the full power mode(s) may be reported with an IE, including but not limited to, the followings: ul-FullPwrMode-r16, ul-FullPwrMode2-MaxSRS-ResInSet-r16, ul-FullPwrMode2-TPMIGroup-r16ul-FullPwrMode2-SRSConfig-diffNumSRSPorts-r16, ul-FullPwrMode1-r16 and so on. In addition, only a subset of precoder can be used for a certain full power capability.

The other UE capabilities may be a maximum number of uplink layers supported by the terminal device and a maximum number of SRS ports supported by the terminal device.

Continue to refer to FIG. 1A, the network device may transmit 120 a radio resource control (RRC) (re)configuration message to configure the CB-based PUSCH. Some information configured by the RRC (re)configuration message is illustrated as below:
SRS configuration,
PUSCH configuration, such as, transformPrecoder, maxRank, codebookSubset and fullpower mode,
Demodulation reference signal (DMRS) configuration, such as, maxLength and dmrs-Type.

Next, the terminal device may transmit 130 an SRS transmission to the network device according to the received RRC (re)configuration message. Then, the network device measures the SRS and searches 140 the suitable precoder, and determines a number of layers and TPMI.

After the above procedure, the network device may transmit 150 an uplink grant (i.e., a DCI message) to schedule the CB-based PUSCH transmission. Specifically, the DCI message comprises an SRI field and a TPMI field.

Based on the received uplink grant, the terminal device may transmit 160 the CB-based PUSCH transmission to the network device.

As discussed above, it is proposed that a terminal device may be deployed with more than one panel. Further, in order to improve the transmission performance, a technology of STxMP is expected to be supported. Specifically, it is expected that multiple panels are deployed at a terminal device, and the multiple panels can be activated at a time and one or more panels can be used for transmission simultaneously.

So far, the technology of STxMP has not been fully discussed and it is proposed that more discussions will be made in the following release 18 of 3GPP.

Specifically, it is expected to study, and if needed, specify the following items to facilitate simultaneous multi-panel uplink transmission for higher uplink throughput/reliability, focusing on FR2 and multi-TRP, assuming up to 2 transmit and receive points (TRPs) and up to 2 panels, targeting CPE/FWA/vehicle/industrial devices (if applicable)
Uplink precoding indication for PUSCH, where no new codebook is introduced for multi-panel simultaneous transmission
   The total number of layers is up to four across all panels and total number of codewords is up to two across all panels, considering single DCI and multi-DCI based multi-TRP operation.
Uplink beam indication for physical uplink control channel (PUCCH)/PUSCH, where unified TCI framework extension in objective 2 is assumed, considering single DCI and multi-DCI based multi-TRP operation
   For the case of multi-DCI based multi-TRP operation, only PUSCH+PUSCH, or PUCCH+PUCCH is transmitted across two panels in a same component carrier.

It can be seen that although some discussions for the STxMP have been made, such discussions are mainly about some assumptions and generalized concepts rather than specific and clear technical solutions. In other words, there are a plurality of pending issues needed to be discussed.

One pending issues is how to exchange capability information. For example, the terminal device with simultaneous multiple panels may have a more complicated coherent type because the antenna ports may be within the same panel or across multiple panels. Further, a per UE or a per panel total power constraint may be considered for single-panel or multi-panel.

Another pending issue is how to configure the SRS resource set associated with the CB-based PUSCH STxMP. Specifically, in the related solution, the SRS resource set applicable for PUSCH scheduled by DCI format 0_1 and DCI format 0_2 are defined by the entries of the higher layer parameter srs-ResourceSetToAddModList and srs-ResourceSetToAddModListDCI-0-2 in SRS-config, respectively. Further, only one SRS resource set can be configured in srs-ResourceSetToAddModList with higher layer parameter usage in SRS-ResourceSet set to ‘codebook’, and only one SRS resource set can be configured in srs-ResourceSetToAddModListDCI-0-2 with higher layer parameter usage in SRS-ResourceSet set to ‘codebook’. However, one SRS resource set maybe not enough for supporting the CB-based PUSCH STxMP.

A further pending issue is how to schedule the CB-based PUSCH STxMP. Specifically, generally speaking, a DCI message may comprise a SRI field indicating a SRS resource set and a TMPI field indicating precoding information and number of layers. In this event, the conventional DCI message cannot indicate two uplink beams. Moreover, the conventional DCI message cannot support to schedule the CB-based PUSCH STxMP.

In addition, in the related solutions, different waveforms may correspond to different codebooks and the terminal device may determine the precoder based on both the currently-used codebook and the TPMI indicated in the DCI message. In the related solution, the waveform information used for PUSCH is indicated by a RRC message. However, the transmission period of RRC message is relative longer. Therefore, it is expected that a dynamic waveform switch is supported. It is still pending about how to implement the dynamic waveform switch and how to determine the precoder if a dynamic waveform switch is enabled.

According to some of the embodiments of the present disclosure, details for supporting the CB-based PUSCH STxMP and the dynamic waveform switch are supported.

In this present disclosure, some terms may refer to same or similar physical meaning and may be used interchangeably. Some exemplary examples are listed as below.
The terms “port(s) used for a uplink transmission”, “port(s) used for a PUSCH transmission”, “port(s) with non-zero PUSCH transmission power” and “port(s) with non-zero uplink transmission power” can be used interchangeably;
The terms “panel(s) used for a uplink transmission”, “panel (s) used for a PUSCH transmission”, “panel(s) with non-zero PUSCH transmission power” and “panel(s) with non-zero uplink transmission power” can be used interchangeably;
The terms “transmission capability information”, “UE capability information”, “capability-related information”, “capability value set”, “panel information” and “panel-related information” can be used interchangeably;
The terms “precoder”, “precoding”, “precoding matrix”, “beam”, “spatial relation information”, “spatial relation info”, “TPMI”, “precoding information”, “precoding information and number of layers”, “precoding matrix indicator (PMI)”, “precoding matrix indicator”, “transmission precoding matrix indication”, “precoding matrix indication”, “TCI state”, “transmission configuration indicator”, “quasi co-location (QCL)”, “quasi-co-location”, “QCL parameter”, “QCL assumption”, “QCL relationship” and “spatial relation” can be used interchangeably;
The terms “single TRP”, “single TCI state”, “single TCI”, “S-TCI”, “single CORESET”, “single control resource set pool”, “S-TRP” and “S-TCI state” can be used interchangeably;
The terms “multiple TRPs”, “multiple TCI states”, “multiple CORESETs” and “multiple control resource set pools”, “multi-TRP”, “multi-TCI state”, “multi-TCI”, “multi-CORESET” and “multi-control resource set pool”, “MTRP” and “M-TCI”, “M-TPR” can be used interchangeably;
The terms “resource(s)”, “resource(s) in a resource set”, “resource set” can be used interchangeably; and
The terms “group”, “subset”, “set” can be used interchangeably.

Further, one panel discussed herein refers to one or more antenna elements deployed at a certain area of a terminal device. A panel discussed herein can refer to downlink panel, uplink panel, panel type, panel status, capability value set, reference signal (RS) resource, RS resource set, antenna port, antenna port group, beam, beam group. In this regard, the terms (and their equivalent expressions) “panel”, “panel type”, “set of antenna port(s)”, “antenna element(s)”, “antenna array(s)” can be used interchangeably.

In addition, panel information discussed herein can refer to UE panel index/identification (ID), downlink panel ID, uplink panel ID, panel type indication, panel status indication, capability value set index, RS resource ID, RS resource set ID, antenna port ID, antenna port group ID, beam ID, beam group ID.

As used herein, the term “TRP” refers to an antenna array (with one or more antenna elements) available to the network device located at a specific geographical location. Although some embodiments of the present disclosure are described with reference to a scenario of multi-TRPs (or a scenario of single TRP) for example, these embodiments are only for the purpose of illustration and help those skilled in the art to understand and implement the present disclosure, without suggesting any limitations as to the scope of the present disclosure. It is to be understood that the present disclosure described herein can be implemented in various manners other than the ones described below.

As used herein, term “SRS transmission” refers to a transmission of SRS resource identified by SRS signal resource indicator (SRI) in a DCI message for uplink grant. Accordingly, term “the latest SRS transmission” refers to the latest transmission of SRS resource identified by SRI in a DCI message for uplink grant.

As used herein, term “network”/“network device(s)” refer to one or more network devices. Accordingly, terms “network”, “network device(s)” and “one or more network devices” can be used interchangeably.

### Example Environment

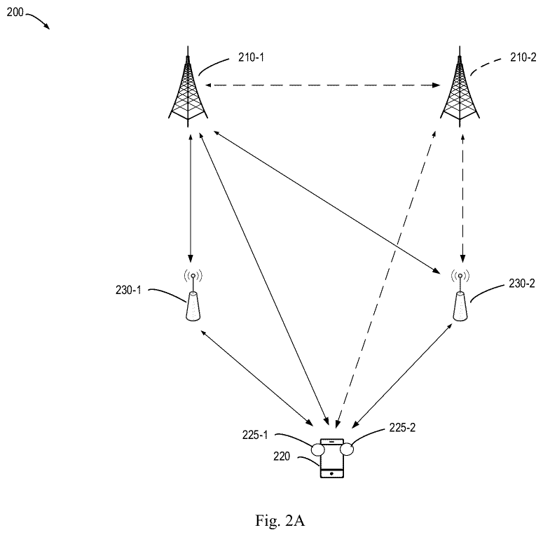

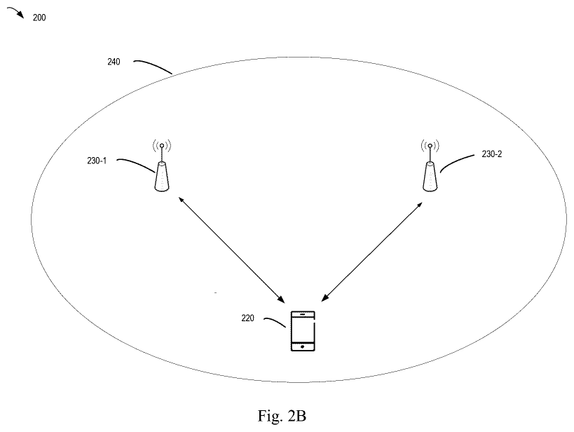

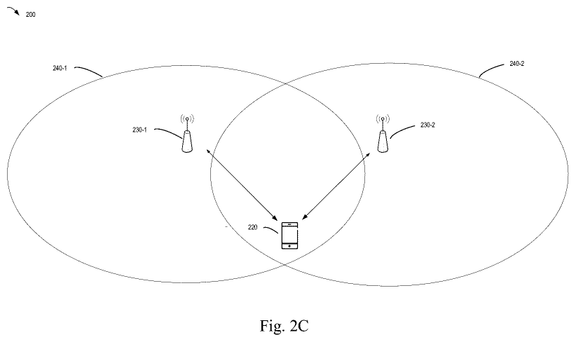

FIG. 2A illustrates an example communication network 200 (also referred to as “network” for brevity sometimes) in which embodiments of the present disclosure can be implemented. The communication network 200 includes a network device 210-1 and an optionally network device 210-2 (collectively or individually referred to as network devices 210). The network device 210 can provide services to a terminal device 220. For purpose of discussion, the network device 210-1 is referred to as the first network device 210-1, and the network device 210-2 is referred to as the second network device 210-2. Further, the first network device 210-1 and the second network device 210-1 can communicate with each other.

In the communication network 200, a link from the network devices 210 (such as, a first network device 210-1 or the second network device 210-2) to the terminal device 220 is referred to as a downlink, while a link from the terminal device 220 to the network devices 210 (such as, a first network device 210-1 or the second network device 210-2) is referred to as an uplink. In downlink, the first network device 210-1 or the second network device 220-1 is a transmitting (Tx) device (or a transmitter) and the terminal device 220 is a receiving (Rx) device (or a receiver). In uplink, the terminal device 220 is a transmitting Tx device (or a transmitter) and the first network device 210-1 or the second network device 210-2 is a Rx device (or a receiver).

In some embodiments, the network device(s) 210 and the terminal device 220 may communicate with direct links/channels.

In addition, the terminal device 220 may be deployed with more than one panel. As illustrated in FIG. 1A, the terminal device 220 is deployed with panels 225-1 and 225-2. In the following, the panels 225-1 and 225-2 may be referred to as the first panel 225-1 and the second panel 225-2, respectively.

In some embodiments, the first panel 225-1 and the second panel 225-2 correspond to different sets of antenna port(s)/antenna element(s)/antenna array(s). As one specific example, the first panel 225-1 corresponds to a first set of antenna port and the second panel 225-corresponds to a second set of antenna port.

Further, in some embodiments, the panels 225-1 and 225-2 may correspond to different sets of capability parameters, respectively.

In the communication network 200, the CB-based PUSCH STxMP is supported. Specifically, the terminal device 220 may perform a CB-based PUSCH over both of the panels 225-1 and 225-2 simultaneously.

Further, in the specific example of FIG. 2A, a multi-TRP transmission also is supported. As illustrated in FIG. 2A, the terminal device 220 may communicate with two TRPs, i.e., the TRPs 230-1 and 230-2 (collectively or individually referred to as TRP 230). For purpose of discussion, the TRP 230-1 is referred to as the first TRP 230-1, and the TRP 230-2 is referred to as the second TRP 230-2.

In addition, in order to support multi-TRP and/or multi-panel, the network device 210 may be equipped with one or more TRPs. For example, the network device 210 may be coupled with multiple TRPs in different geographical locations to achieve better coverage. In one specific example embodiment, the first network device 210-1 is equipped with the first TRP 230-1 and the second TRP 230-2. Alternatively, in another specific example embodiment, the first network device 210-1 and the second network device 210-2 are equipped with the first TRP 230-1 and the second 230-2, respectively.

In some embodiments, the first TRP 230-1 and the second TRP 230-2 are associated with different control resource set pools (CORESET pools). For example, the first TRP 230-1 is associated with a first control resource set pool while the second TRP 230-2 is associated with a second control resource set pool.

Further, both a single TRP mode transmission and multi-TRP transmission are supported by the specific example of FIG. 2A. Specifically, in case of the single TRP mode, the terminal device 220 communicates with the network via the first TRP 230-1/second TRP 230-2. Alternatively, in case of the multi-TRP mode, the terminal device 220 communicates with the network via both of the first TRP 230-1 and the second TRP 230-2.

As one specific example embodiment, during the CB-based PUSCH STxMP, the terminal device 220 communicates with the first TRP 230-1 via panel 225-1 and communicates with the second TRP 230-2 via panel 225-2 simultaneously.

Further, the network device(s) 210 may provide one or more serving cells and the first TRP 230-1 and the second TRP 230-2 may be included in a same serving cell or different serving cells. In other words, both an inter-cell transmission and an intra-cell transmission are supported by the specific example of FIG. 2A.

FIG. 2B shows an example scenario of the communication network 200 as shown in FIG. 2A. In the specific example of FIG. 2B, the first TRP 230-1 and the second TRP 230-2 are included in a same serving cell 240. In this event, the multi-TRP transmission is performed as an intra-cell transmission.

FIG. 2C shows another example scenario of the communication network 200 as shown in FIG. 2A. In the specific example of FIG. 2C, the first TRP 230-1 and the second TRP 230-2 are included in different serving cells 240-1 and 240-2. In this event, the multi-TRP transmission is performed as an inter-cell transmission.

The communications in the communication environment 200 may conform to any suitable standards including, but not limited to, Long Term Evolution (LTE), LTE-Evolution, LTE-Advanced (LTE-A), Wideband Code Division Multiple Access (WCDMA), Code Division Multiple Access (CDMA) and Global System for Mobile Communications (GSM) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G), 5.5G, 5G-Advanced networks, or the sixth generation (6G) communication protocols.

It is to be understood that the numbers of devices (i.e., the terminal device 220, the panel 225, the network device 210, the TRP 230 and the cell 240) and their connection relationships and types shown in FIGS. 2A to 2C are only for the purpose of illustration without suggesting any limitation. The communication network 200 may include any suitable numbers of devices adapted for implementing embodiments of the present disclosure.

### Example Processes

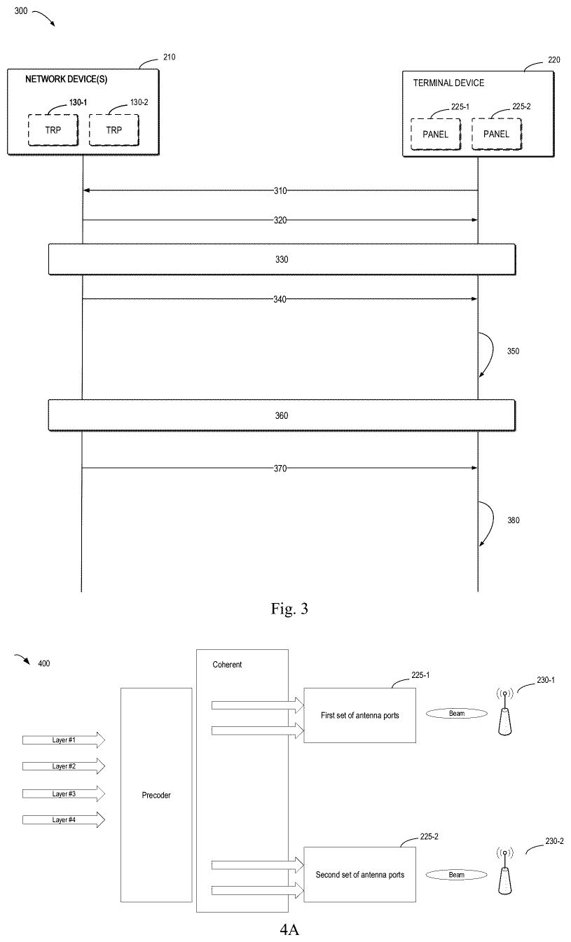

Principle and implementations of the present disclosure will be described in detail below with reference to FIG. 3, which show a signaling chart illustrating process 300 of communication according to some example embodiments of the present disclosure. For the purpose of discussion, the process 300 will be described with reference to FIGS. 2A to 2C.

The process 300 may involve the terminal device 220, the network device 210 (either or both of the first network device 210-1 and the second network device 210-2), and optionally may involve the TRPs 230 (including the first TRP 230-1 and the second TRP 230-2). In other words, the implementations of some embodiments do not depend on the TRPs 230. The terminal device 220 may be deployed with the first panel 225-1 and the second panel 225-2. Further, the first panel 225-1 corresponds to a first set of antenna port (be represented as ports (p0, . . . , p1−1)) and the second panel 225-2 corresponds to a second set of antenna port (be represented as ports (p1, . . . , p−1)).

Additionally, the first TRP 230-1 is connected to the first network device 210-1, while the second TRP 230-2 is connected to the first network device 210-1/second network device 210-2. In addition, the first TRP 230-1 and the second TRP may be in a same serving cell and in different serving cells.

In the following text, although some embodiments of the present disclosure are described with reference to two TRPs and two panels, these embodiments are only for the purpose of illustration and help those skilled in the art to understand and implement the present disclosure, without suggesting any limitations as to the scope of the present disclosure. It is to be understood that the present disclosure described herein can be implemented in various manners other than the ones described below.

Further, it is to be understood that the operations at the terminal device 220 and the network device 210 should be coordinated. In other words, the network device 210 and the terminal device 220 should have common understanding about configuration, parameter and so on. Such common understanding may be implemented by any suitable interactions between the network device 210 and the terminal device 220 or both the network device 210 and the terminal device 220 applying the same rule/policy. In the following, although some operations are described from a perspective of the terminal device 220, it is to be understood that the corresponding operations should be performed by the network device 210. Similarly, although some operations are described from a perspective of the network device 210, it is to be understood that the corresponding operations should be performed by the terminal device 220. Merely for brevity, some of the same or similar contents are omitted here.

In addition, in the following description, some interactions are performed among the terminal device 220 and the network device 210 (such as, exchanging capability-related information, configuring/scheduling/activating resource/transmission and so on). It is to be understood that the interactions may be implemented either in one single signaling/message or multiple signaling/messages, including system information, RRC message, DCI message, uplink control information (UCI) message, MAC CE and so on. The present disclosure is not limited in this regard.

In some embodiments, the one or more interaction may be specific to a particular panel, a TRP, a capability value, a control resource set (CORESET) and so on. In this way, the CB-based PUSCH STxMP may be configured/activated flexibly.

Moreover, it should be understood that although feature(s)/operation(s) are discussed in specific example embodiments separately, unless clearly indicated to the contrary, these feature(s)/operation(s) described in different example embodiments may be used in any suitable combination.

### Example Processes for Exchanging Transmission Capability Information

According to some embodiments of the present disclosure, the terminal device 220 and the network device 210 may communicate transmission capability information (also referred to as “UE capability information”, “capability-related information”, “capability value set”, “panel information” or “panel-related information” sometimes) to enable the embodiments according to the present disclosure, which will be discussed as below.

Reference is now made to FIG. 3, which illustrates signaling flow 300 for communication according to some example embodiments of the present disclosure. As illustrated in FIG. 3, the terminal device 220 transmits 302 the transmission capability information to the network device 210. During this interactive procedure, certain rules associated with the embodiments of the present disclosure may be stipulated, and the related re-defined/newly-introduced parameters may be exchanged between the terminal device 220 and the network device 210.

In some embodiments, the transmission capability information is transmitted via an RRC message. In some other embodiments, the transmission capability information is transmitted via a DCI message, MAC CE and any suitable signalling/message(s).

In some embodiment, the transmission capability information comprises a transmission mode associated with a STxMP (i.e., a simultaneous transmission with the plurality of panels/sets of antenna ports). Some transmission modes defined in this discourse will be discussed as below.

In some example embodiments, the transmission mode is one of the following:
Coherent joint transmission (CJT), with multiple activated panels/sets of antenna ports;
Non-coherent joint transmission (NCJT), with multiple activated panels/sets of antenna ports;
   Different layers per panels/sets of antenna ports, or, to different TRPs; and
   Different TBs per panels/sets of antenna ports, or, to different TRPs;
Same transport block (TB) space division multiplexing, SDM, repetition (referred to as SDM repetition for brevity) PUSCH per panels/sets of antenna ports, or, to different TRPs.

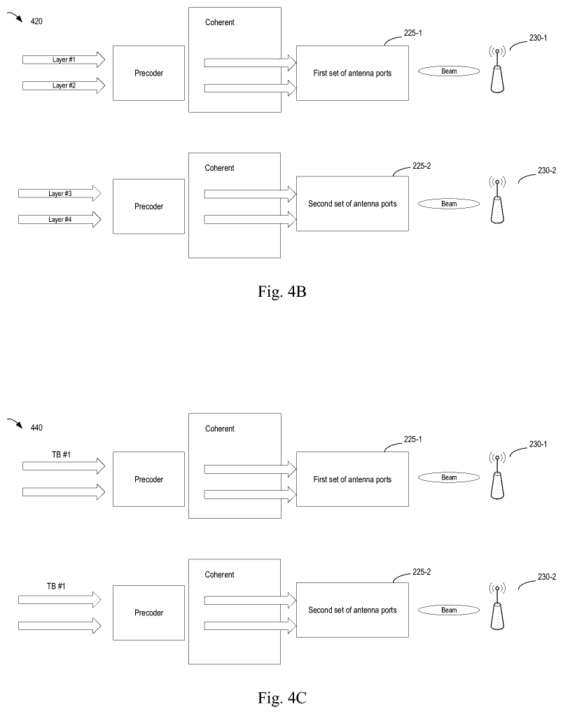

FIG. 4A illustrates an example 400 of transmission mode of CJT. As illustrated in FIG. 4A, all the antenna ports (regardless whether the antenna ports are comprised in the first panel 225-1 or the second panel 225-2) may be used jointly.

FIG. 4B illustrates an example 420 of transmission mode of NCJT. As illustrated in FIG. 4B, the first panel 225-1 and the second panel 225-2 are non-coherent, while the antenna ports within a same panel are coherent. In the specific example of FIG. 4B, both of one-CW or two-CWs transmission are supported. In some embodiments, the mapping of CW-to-layer allows that the two-CWs transmissions is transmitted with more than 4 layers, while two CWs can be supported by transmitting one TB per panel/TRP and each of the two CWs can be mapped to layers #1˜#4.

In the specific example of FIG. 4B, one codeword (CW) i.e., one TB, is divided into four layers (layers #1˜#4).

In some embodiments, different layers may be transmitted by different panels simultaneously. Specifically, layers (0, . . . , v1−1) are transmitted by the first panel 225-1 and layers (v1, . . . , v−1) are transmitted by the second panel 225-2, where v1 is the number of layers transmitted via the first panel 225-1, and v is the total number of layers of the CW via both the first and second panels 225. As illustrated in FIG. 4B, the layers #1 and #2 are transmitted via the first panel 225-1 while the layers #3 and #4 are transmitted via the second panel 225-2.

In some embodiments, different precoding matrices (i.e., precoders) may be used by different panels. Specifically, a first precoding matrix is used by the first panel 225-1 and the second precoding matrix is used by the second panel 225-2. As illustrated in FIG. 4B, the precoding matrix #1/precoder #1 is used by the first panel 225-1 while the precoding matrix #2/precoder #2 is used by the second panel 225-2.

In some embodiments, different beamforming are used by different panels. As a result, a first beam may be formed by the first panel 225-1 and pointed to the first TRP 230-1, a second beam may be formed by the second panel 225-2 and pointed to the second TRP 230-2. In this way, the first and second TRPs 230 may process the uplink transmission (such as, a CB-based PUSCH STxMP) received PUSCH jointly.

It should be understood that as a general rule, the non-coherent joint transmission may be performed among different panels/ports/beams/layers to different TRPs.

FIG. 4C illustrates an example 340 of transmission mode SDM repetition. As illustrated in FIG. 4C, the first panel 225-1 and the second panel 225-2 are non-coherent, while the antenna ports within a same panel are coherent.

In some embodiments, a same TB is transmitted to different multiple TRPs simultaneously via different panels. Specifically, a same number of layers is assumed for different panels. Specifically, layers (0, . . . , v) are transmitted by the first panel 225-1 and the second panel 225-2, where v is the total number of layers of the CW via both the first and second panels 225.

In some embodiments, different precoding matrices (i.e., precoders) may be used by different panels. Specifically, a first precoding matrix is used by the first panel 225-1 and the second precoding matrix is used by the second panel 225-2. As illustrated in FIG. 4C, the precoding matrix #1/precoder #1 is used by the first panel 225-1 while the precoding matrix #2/precoder #2 is used by the second panel 225-2.

In some embodiments, different beamforming are used by different panels. As a result, a first beam may be formed by the first panel 225-1 and pointed to the first TRP 230-1, a second beam may be formed by the second panel 225-2 and pointed to the second TRP 230-2. In this way, the first and second TRPs 230 may process the uplink transmission (such as, a CB-based PUSCH STxMP) received PUSCH jointly (by soft combining) or separately.

In some embodiment, the transmission capability information comprises a hybrid beamforming type associated with a digital precoding manner and an analog beamforming manner.

In some embodiments, the digital precoding manner may be one of the following,
Joint precoding across panels/for multiple TRPs,
Separate precoding per panel/for each TRP,
   Different layers/TB per panel/TRP.

In some embodiments, the analog beamforming manner may be one of the following,
Full connected: One antenna port is connected with all antenna elements,
   the same beam formed by multiple panels/towards different TRPs,
Sub-array connection: One antenna port is connected with a subset of antenna elements,
   different beams formed by one panel/towards different TRPs.

FIGS. 5A to 5D illustrate four examples of antenna structure corresponding to different hybrid beamforming types.

The other transmission capability information comprises:
a first coherence type indicating a panel-level coherence capability,
a second coherence type indicating a port-level coherence capability within a panel,
a first full power mode indicating a panel-level full power capability, or
a second full power mode indicating a port-level full power capability within a panel.

In some embodiments, the first full power mode is one of the following:
a first panel-level full power mode indicating that a full power is achieved regardless of a number of panels used for the uplink transmission; That is, a panel-level full power mode is supported, and the terminal device 220 can deliver with the maximum output even a subset of panels are used for transmission, which can be considered as per UE power constraint;
a second panel-level full power mode indicating that the full power is enabled to be delivered when all panels of the terminal device 220 are used for the uplink transmission; That is, a panel-level full power mode 1 is supported, and the terminal device 220 can only transmit with the maximum output when all panels are used for transmission; or
a third panel-level full power mode indicating that the full power is enabled when all panels of the terminal device 220 are used for the uplink transmission or at least one specific precoding matrix indicator (TPMI) or TPMI combination is configured; That is, a panel-level full power mode 2 is supported, and the terminal device 220 can only transmit with the maximum output when all panels are used for transmission, or the terminal device 220 can only transmit with the maximum output when the reported TPMI/TPMI combination is indicated.

Additionally, in some embodiments, if the first full power mode is the third panel-level full power mode, the transmission capability information further comprises information about the at least one specific TPMI or TPMI combination.

In addition, the coherence type (including the first and second coherence types) and full power mode (including the first and second full power modes) depend on either or both of the supported STxMP mode (i.e., the transmission mode) and UE hybrid beamforming type (i.e., the hybrid beamforming type). Specifically, in some embodiments, the first coherence type, the second coherence type, the first full power mode and the second full power mode are associated with the transmission mode. Alternatively, or in addition, in some other embodiments, the first coherence type, the second coherence type, the first full power mode and the second full power mode are associated with the hybrid beamforming type associated with a digital precoding manner and an analog beamforming manner. Such association(s) will be discussed with reference to FIGS. 5A to 5D.

FIG. 5A illustrates an antenna structure where a combination of joint precoding and full connected is supported. In the specific example of FIG. 5A, the coherent type is full coherent and both the first and the second can be full power mode 0, full power mode 1, or full power mode 2. Such antenna structure is especially suitable for an uplink CJT (such as, a coherent STxMP PUSCH transmissions).

FIG. 5B illustrates an antenna structure where a combination of separate precoding and sub-array (i.e., separated digital precoding and sub-array connection analog beamforming) is supported. In the specific example of FIG. 5B, the transmission mode is NCJT (such as, a non-coherent STxMP PUSCH transmissions), and the coherent type is partial coherent (i.e., full coherent within the first/second panel and non-coherent across the first panel 230-1 and the second panel 230-2). Further, in the specific example of FIG. 5B, the first full power mode is full power mode 1 or 2 (i.e., full power mode 1 or 2 across the first panel 230-1 and the second panel 230-2) and the second full power mode is full power mode 0 (i.e., full power mode 0 within the first/second panel). Such antenna structure is especially suitable for an uplink NCJT, or an uplink simultaneous SDM repetition where the same TB is replaced with a subset of layers.

FIG. 5C illustrates an antenna structure where a combination of joint precoding and sub-array (i.e., joint precoding and sub-array connection analog beamforming) is supported. In the specific example of FIG. 5C, the coherent type is partial coherent (i.e., full coherent within the first/second panel and non-coherent across the first panel 230-1 and the second panel 230-2). Further, in the specific example of FIG. 5C, the first full power mode is full power mode 1 or 2 (i.e., full power mode 1 or 2 across the first panel 230-1 and the second panel 230-2) and the second full power mode is full power mode 0 (i.e., full power mode 0 within the first/second panel). Such antenna structure especially is suitable for an uplink simultaneous SDM repetition.

FIG. 5D illustrates an antenna structure where a combination of separate precoding and full connected (i.e., separate precoding and full connection analog beamforming) is supported. In the specific example of FIG. 5D, the coherent type is full coherent and both the first and the second can be full power mode 0, full power mode 1, or full power mode 2.

In some embodiments, the capability value set corresponds to a panel (a physical or a logical entity) deployed at the terminal device 220.

Alternatively, or in addition, in some embodiments, the capability value set may correspond to a specific panel type. In one example embodiment, the type of the panel may be defined by the supported number of SRS ports, such as, type #1 corresponding to 1-port SRS, type #2 corresponding to 2-port SRS, type #3 corresponding to 4-port SRS and the likes.

Alternatively, or in addition, in some embodiments, the capability value set may correspond to a specific panel status. In one example embodiment, the panel status may be defined by the activated number of panels, such as, status #1 corresponding to single-panel transmission, status #2 corresponding to two-panel simultaneous transmission, status #3 corresponding to four-panel simultaneous transmission and the likes. This example embodiment is especially suitable the scenario where the multi-panel simultaneous transmission is supported.

Due to the above different interpretation of the capability value set, the terminal device 220 may report the transmission capability information via different combinations of capability value sets. The present disclosure is not limited in this regard.

In one specific example, the terminal device 220 transmits bellow capability value sets as transmission capability information to the network device 210:
Capability value set #1, comprising one of the following: a maximum number of SRS ports per panel, (such as, 2-port), a number of repeated capability value set #(such as, 2, which implies that the terminal device 220 is equipped with two symmetric panels), the second coherence type indicating a port-level coherence capability within a panel and the second full power mode indicating a port-level full power capability within a panel; and
Capability value set #2, comprising one of the following: a maximum number of SRS ports for STxMP (such as, 4-port), a transmission mode associated with a simultaneous transmission with the plurality of sets of antenna ports, the hybrid beamforming type associated with a digital precoding manner and an analog beamforming manner, the first coherence type indicating a panel-level coherence capability, the second coherence type indicating a port-level coherence capability within a panel, the first full power mode indicating a panel-level full power capability and the second full power mode indicating a port-level full power capability within a panel.

According to the above procedure, the capability information about STxMP may be better exchanged between the terminal device 220 and the network device 210.

It is to be understood that the above illustrated transmission capability information is given for illustrative purpose only. In other embodiments, any suitable transmission capability information associated with the embodiments discussed herein may be communicated during this stage. The present disclosure is not limited in this regard.

### Example Processes for Configuring and Scheduling the STxMP

Continue to refer to FIG. 3, the network device 210 may generate and transmit 320 a SRS configuration (such as, a RRC message) which may configure the SRS resources for performing the PUSCH STxMP to the terminal device 220. In some embodiments, the SRS configuration includes the number of SRS resource sets, SRS resources in a SRS resource set, SRS ports and so on. Additionally, in some embodiments, a SRS resource set (with ‘usage’=‘codebook’) may be configured dedicatedly for the STxMP PUSCH.

In some embodiments, the SRS configuration is generated based on the transmission capability information as discussed above. Specifically, the SRS configuration is generated depends on at least one of the following factors: capability value sets, the transmission mode (i.e., STxMP modes), the hybrid beamforming type (i.e., UE hybrid beamforming types), the first coherence type, the second coherence type, the first full power mode, the second full power mode. Additionally, the SRS configuration also may be generated depends on waveform information and DCI transmission mode (i.e., single DCI mode or multi DCI mode).

Further, one or more SRS resource sets may be indicated in the SRS configuration. As one specific example embodiment, the terminal device 220 is equipped with two 2-port panels (such as, the first panel 225-1 and the second panel 225-2) and can use one or both of the panels for an uplink transmission to two TRPs (such as, TRPs 230). In this specific example embodiment, the related SRS resource sets that may be indicated by the SRS configuration comprise at least part of the following:
a first SRS resource set associated with a first panel or a first capability value set of the terminal device 220, i.e, a SRS resource set #1 for the first panel 225-1 or the first TRP 230-1;
a second SRS resource set associated with a second panel or a second capability value set of the terminal device 220, i.e, a SRS resource set #2 for the first panel 225-2 or the first TRP 230-2; and
a third SRS resource set associated with both the first and second panels or both the first and second capability value sets of the terminal device 220, i.e, a SRS resource set #3 for STxMP PUSCH

The SRS configuration may indicate one or more of the first to third SRS resource sets, as discussed below in detail.

Further, in this specific example, a 2-port SRS resource is comprised in the SRS resource set #1, a further 2-port SRS resource is comprised in the SRS resource set #2 and a 4-port SRS resource is comprised in the SRS resource set #3.

In addition, the ports of the 4-port SRS resources comprised in the SRS resource set #3 may be divided into different port group, such as, a first port group (such as, port group #1:{port 0, port 1}) and a second port group (such as, port group #2: {port 2, port 3}).

In addition, two uplink beams can be configured per resource, by using two reference signals in QCL-info configuration or spatial relation information, sharing two unified uplink TCI states or two unified joint TCI states or applying the two beams reported together with panel information in correspondence report. In addition, one uplink beam is applied to one port group.

In this way, the dedicated SRS resource set(s) can be configured for PSUCH STxMP.

Then, the terminal device 220 may perform 330 an SRS transmission to the network device 210. By measuring the SRS transmission, the network device 210 may generate and transmit 340 an uplink grant (i.e., a DCI message) to the terminal device 220 for scheduling an uplink transmission over at least two of the plurality of sets of antenna ports (i.e., a STxMP PUSCH). In particular, the DCI message indicates first information about SRS resources associated with the uplink transmission, second information about the precoding information associated with the uplink transmission and third information indicating a transmission mode of the uplink transmission.

Based on the DCI message, the terminal device 220 may performs 360 the uplink transmission (i.e., the STxMP PUSCH) with the network device 210.

According to some embodiments of the present discourse, the configuration message (i.e., the RRC message) and the uplink grant (i.e., the DCI message) are enhanced.

In an example aspect, a SRS resource set configured dedicatedly for StxMP may be introduced and configured via the RRC message. In another example aspect, the improved DCI message may comprise a field to dynamically indicate different STxMP mode. Further, the number, bit-width, and interpretation of SRI(s) and TPMI field(s) in improved DCI depends on the SRS resource indicator in the DCI message and the SRS configuration in the improved RRC message. In this way, the PUSCH STxMP may be well configured and scheduled.

Further, some other parameters configured for PUSCH (such as, maxRank, codebookSubset, fullpower mode and so on) may be associated with at least one of reported transmission capability information (i.e., UE capability value), transmission mode. In some embodiments, in case of different transmission modes, the TPMI field/SRI field comprised in the DCI message corresponds to different values of one or more some other parameters configured for PUSCH. Specifically, in some embodiments, the values of other parameters configured for PUSCH (such as, maxRank, codebookSubset, fullpower mode and so on) may be associated with at least one of the following: the SRI and TPMI fields the configured SRS resource(s). Further, the values of any of the other parameters configured for PUSCH (such as, maxRank, codebookSubset, fullpower mode and so on) may be indicated either implicitly or explicitly.

In some example embodiments, below information may be used for scheduling uplink transmission:
first information about SRS resources associated with the at least one uplink transmission,
second information about the precoding information associated with the at least one uplink transmission; or third information indicating a transmission mode of the at least one uplink transmission.

In one specific example embodiments, the first, second and third information is comprised in a DCI message. Alternately, or in addition, in another specific example embodiments, the first and second is comprised in a DCI message while the third information is comprised in a RRC or MAC CE message.

Comprising the first and second in the DCI message maximizing the compatibility with the current uplink transmission scheduling procedure, while comprising the third in the DCI/RRC/MAC CE message maximizing feasibility for indicating the STxMP mode.

Further, in some embodiment, the third information is the “SRS resource set indicator” field in the DCI message. Specifically, different states of “SRS resource set indicator” field correspond to different STxMP modes. In this way, a dynamic indication of different STxMP modes is implemented by using different states of “SRS resource set indicator” field in the DCI.

For better understanding, some example processed will be described one by one.

### Example Processes Associated With Three SRS Resource Sets

In some embodiments, the terminal device 220 receives a first SRS configuration indicating:
a first SRS resource set associated with a first panel or a first capability value set of the terminal device 220,
a second SRS resource set associated with a second panel or a second capability value set of the terminal device 220, and
a third SRS resource set associated with both the first and second panels or both the first and second capability value sets of the terminal device 220.

In some embodiments, the SRS resources comprised in the third SRS resource set are used by the terminal device 220 first, such that the network device 210 may determine the number of layers and precoder(s) for subsequent PUSCH transmission.

According to some embodiments of the present discourse, the first SRS resource set and the second SRS resource set may be configure/trigger on demand, and the DCI with different structures may be generated accordingly.

In some embodiments, the SRS resources in the third SRS resource set comprise two port groups, a number of ports in the first port group equals to a number of ports of SRS resources in the first SRS resource set and a number of ports in second group equals to a number of ports of SRS resources in the second SRS resource set.

In some embodiments, if the transmission mode is NCJT, the network device 210 may configure/trigger the SRS resources comprised in the SRS resource sets #1 and #2 based on total rank obtained with the SRS resource set #3, such that the precoder for each panel/or each TRP may be obtained. Accordingly, in some embodiments, if the third information indicates that the uplink transmission is a NCJT transmission, the DCI message comprises first information and second information, where the first information comprises a first SRI associated with the first SRS resource set and a second SRI associated with the second SRS resource set, while the second information comprises a first TPMI corresponding to the first SRI and a second TPMI corresponding to the second SRI.

In some embodiments, if the third information indicates that the uplink transmission is the NCJT transmission and the uplink transmission is transmitted with one codeword, the first TPMI indicates a first precoder to be applied over at least one layer and the second TPMI indicates a second precoder to be applied over at least one further layer. In particular, a total number of layers of the first and second precoders equals to a number of layers corresponds to the one codeword.

In one specific example embodiments, the first TPMI indicates the first precoder to be applied over layers (0, . . . , v1−1) which corresponds to the first SRI, and the second TPMI indicates the second precoder to be applied over layer (v1, . . . , v−1) which corresponds to the second SRI, where v1 is the number of layers transmitted via the first UE panel (i.e., the first panel 225-1), v is the total number of layers of the one CW, via both panels (i.e., the first panel 225-1 and the second panel 225-2).

In some embodiments, if the third information indicates that the uplink transmission is the NCJT transmission and the uplink transmission is transmitted with a first codeword and a second codeword, the first TPMI indicates a first precoder to be applied over at least one layer, and the second TPMI indicates a second precoder to be applied over at least one further layer. In particular, the number of the at least one layer corresponds to the first codeword and the number of the at least one further layer corresponds to the second codeword.

In one specific example embodiments, the first TPMI indicates the first precoder to be applied over layers (0, . . . , v1−1) which corresponds to the first SRI, and the second TPMI indicates the second precoder to be applied over layers (0, . . . , v2-1) which corresponds to the second SRI, where v1 is the number of layers of the first CW and v2 is the number of layers of the second CW.

Additionally, in some embodiments, in case that there are two CWs (i.e., TBs), the DCI message comprise two modulation and coding scheme (MCS)/redundancy versions (RV)/new data indicators (NDI) fields. In view of this, whether one CW or two CWs are applied can be determined by a number of MCS/RV/NDI fields.

In some embodiments, if the transmission mode is SDM, the network device 210 may configure/trigger the SRS resources comprised in the SRS resource sets #1 and #2 with two uplink beams. Accordingly, in some embodiments, if the third information indicates that the uplink transmission is a SDM transmission, the DCI message comprises first information and second information, where the first information comprises a first SRI associated with the first SRS resource set and a second SRI associated with the second SRS resource set, while the second information comprises a first TPMI corresponding to the first SRI and a second TPMI corresponding to the second SRI.

In some embodiments, if the third information indicates that the uplink transmission is the SDM repetition, a number of layers associated with the first TPMI is the same with a number of layers associated with the second TPMI.

Additionally, in some embodiments, for SDM repetition (such as, PUSCH repetition type A or PUSCH repetition type B), the first port group and the second port group are applied simultaneously for K repetitions with all K consecutive slots (type A), or K nominal repetitions (type B).

In some embodiment, if the transmission mode is NCJT or SDM, or if the DCI message comprises two TPMIs (e.g., the first TPMI and the second TPMI) and two SRIs (e.g., the first SRI and the second SRI), the number of ports associated with the first TPMI corresponds to the number of ports of the SRS resource associated the first SRI, and the number of ports associated with the second TPMI corresponds to the number of ports of the SRS resource associated with the second SRI.

In some embodiment, if the transmission mode is NCJT or SDM, or if the DCI message comprises two TPMIs (e.g., the first TPMI and the second TPMI) and two SRIs (e.g., the first SRI and the second SRI), at least one of following maxRank values may be configured for PUSCH transmission: a first value of maxRank associated with the first TPMI (e.g., r1), a second value of maxRank associated with the second TPMI (e.g., r2), a third value of maxRank associated with both the first and second TPMIs (e.g., r, where r=r1+r2). In some embodiment, only the third value of maxRank is configured, while the first value of maxRank associated with the first TPMI is ceil(r/2) (or floor(r/2)), and the second value of maxRank associated with the second TPMI is floor(r/2) (or ceil(r/2)) accordingly. The first, the second and third values of maxRank are determined based on UE capabilities, such as, determined to be the maximum supported SRS port number or the maximum supported uplink layers for the first panel 225-1, the second panel 225-2 and both the first and second panels 225, respectively. In addition, the same maxRank value is associated with the first TPMI and the second TPMI.

In some embodiment, if the transmission mode is NCJT or SDM, or if the DCI message comprises two TPMIs (e.g., the first TPMI and the second TPMI) and two SRIs (e.g., the first SRI and the second SRI), at least one of the following codebookSubset values may be configured for PUSCH transmission: a first codebookSubset value associated with the first TPMI, a second codebookSubset value associated with the second TPMI, a third codebookSubset value associated with both the first and the second TPMIs. The first, the second and the third codebookSubset values are determined based on the UE capabilities, such as, determined to be coherent types for the first panel 225-1, the second panel 225-2 and both the first and second panels 225, respectively. The value of codebookSubset can be one of the following: fullAndPartialAndNonCoherent, partialAndNonCoherent and nonCoherent. In addition, the same codebookSubset value is associated with the first TPMI and the second TPMI.

In some embodiment, if the transmission mode is NCJT or SDM, or if the DCI message comprises two TPMIs (e.g., the first TPMI and the second TPMI) and two SRIs (e.g., the first SRI and the second SRI), at least one of the following fullpowermode values, may be configured for PUSCH transmission: the first fullpowermode value associated with the first TPMI, the second fullpowermode value associated with the second TPMI, the third fullpowermode value associated with both the first and the second TPMIs, the fourth fullpowermode value applied between the first and the second TPMIs. The first, the second and the third fullpowermode values are determined based on the UE capabilities, such as, full power mode within the first panel 225-1, within the second panel 225-2, and within each panel 225, respectively. The fourth fullpowermode value is determined based on the UE capability, such as, determined to be panel-level full power mode. Any of the first, the second and the third fullpowermode values can be one the following: port-level fullpowermode0, port-level fullpowermode1, port-level fullpowermode2. The fourth fullpowermode value can be one of the following: panel-level fullpowermode0, panel-level fullpowermode1, panel-level fullpowermode2. In addition, the same fullpowermode value is associated with the first TPMI and the second TPMI.

In some embodiments, if the transmission mode is CJT, the network device 210 may calculate the rank by measuring 4-port SRS, assuming ideal backhaul between two TRPs for jointly channel acquisition. Accordingly, in some embodiments, if the third information indicates that the uplink transmission is a CJT transmission, The DCI message comprises first information and second information, where the first information comprises a third SRI associated with the third SRS resource set, and the second information comprises a third TPMI corresponding to the third SRI.

In one specific example embodiments, the third TPMI indicates the third precoder to be applied over layers (0, . . . , v−1) which corresponds to the third SRI. As a result, the third SRS resource set and third SRI corresponds to a capability value set with the larger number of SRS ports. Alternatively, the third SRS resource set and third SRI corresponds to a SRS resource set with larger number of SRS ports.

In some embodiment, if the transmission mode is CJT, or if the DCI message comprises one TPMI (e.g., the third TPMI) and one SRI (e.g., the third SRI), the number of ports associated with the third TPMI corresponds to the number of ports of the SRS resource associated the third SRI.

In some embodiment, if the transmission mode is CJT, or if the DCI message comprises one TPMI (e.g., the third TPMI) and one SRI (e.g., the third SRI), the following maxRank values may be configured for PUSCH transmission: the fourth value of maxRank associated with the third TPMI. The fourth value of maxRank is determined based on UE capability, such as determined to be the maximum supported SRS port number or maximum supported uplink layers for both the first and second panels 225.

In some embodiment, if the transmission mode is CJT, or if the DCI message comprises one TPMI (e.g., the third TPMI) and one SRI (e.g., the third SRI), the codebookSubset value configured for PUSCH transmission may be a fourth codebookSubset value associated with the third TPMI. The fourth codebookSubset value is determined based on the UE capability, such as, determined to be coherent type for both ten first and the second panels 225. The value of codebookSubset can be: fullAndPartialAndNonCoherent.

In some embodiment, if the transmission mode is CJT, or if the DCI message comprises one TPMI (e.g., the third TPMI) and one SRI (e.g., the third SRI), at least one of the following fullpowermode values may be configured for PUSCH transmission: the fifth fullpowermode value and the sixth fullpowermode associated with the third TPMI. The fifth fullpowermode value is determined based on the UE capability, such as, determined to be full power mode within each panel 225. The sixth fullpowermode value is determined based on the UE capability, such as, determined to panel-level full power mode. The fifth fullpowermode value can be one the following: port-level fullpowermode0, port-level fullpowermode1, port-level fullpowermode2. The sixth fullpowermode value can be one of the following: panel-level fullpowermode0, panel-level fullpowermode1, panel-level fullpowermode2.

It is to be understood that the DCI message may optionally reserve some codepoints for other scenario, depending on the bitwidth of related field (i.e., the third information).

### Example Processes Associated With One SRS Resource Sets

In some embodiments, the terminal device 220 receives a second SRS configuration indicating:
a third SRS resource set associated with both the first and second panels or both the first and second capability value sets of the terminal device 220.

That is, the third SRS resource set is transmitted alone and the first and second SRS resource sets are not necessary. In other words, a SRS resource set (with ‘usage’=‘codebook’) may be configured dedicatedly for PUSCH STxMP.

Accordingly, in some embodiments, the DCI message comprises first information and second information, where the first information comprises a third SRI associated with the third SRS resource set, and the second information comprises at least one TPMI associated with at least one transmission precoder selected from an uplink codebook. In particular, the at least one transmission precoder has a corresponding number of ports corresponding to the at least one TPMI. In one specific example embodiments, a 4-port SRS is transmitted, while 2-port TPMIs are used (for example, for the scenario of NCJT STxMP mode).

In some embodiments, if the transmission mode is NCJT, the network device 210 can calculate ranks restricted in different port groups (such as, port group #1 and port group #2) respectively, and each TRP still can determine per-TRP/per-UE-panel rank and precoder. Accordingly, in some embodiments, if the third information indicates that the uplink transmission is a NCJT transmission, the DCI message comprises first information and second information, where the first information comprises a third SRI associated with the third SRS resource set, and the second information comprises a first TPMI corresponding to a first port group of the third SRS resource set and a second TPMI corresponding to a second port group of the third SRS resource set.

In some embodiments, the number of ports in the first port group and the number of ports in the second port group for corresponding TPMI(s) can be explicitly indicated, based on UE panel capability, based on port group configuration and so on.

Specifically, in some embodiments, either or both of a number of ports in the first port group and a number ports in of the second port group are determined by the terminal device 220 and the network device 210 based on at least one of the following:
port group information comprised in the DCI message,
a first number of ports corresponding to the first TPMI,
a second number of ports corresponding to the second TPMI,
a number of ports of SRS resources comprised in the third SRS resource set,
port group information comprised in the second SRS configuration, or
capability information corresponding to a first and second control resource set pools of the terminal device 220.

In some embodiment, the number of ports in the first or the second port group is one half of the number of ports of SRS resources in the third SRS resource set.

Additionally, each TRP can do the measurement independently. In other words, the network device 210 may determine the number of the first port group and the number of the second port group based on a measured signal quality of each port of the terminal device 220. In this way, even there is no explicit port group configuration, the network device 210 also may determine the number of the first port group and the number of the second port group.

In some embodiments, if the third information indicates that the uplink transmission is the NCJT transmission and the uplink transmission is transmitted with one codeword, the first TPMI indicates a first precoder to be applied over at least one layer and the second TPMI indicates a second precoder to be applied over at least one further layer. In particular, a total number of layers of the first and second precoders equals to a number of layers corresponds to the one codeword.

In one specific example embodiments, the first TPMI indicates the first precoder to be applied over layers (0, . . . , v1−1), and the second TPMI indicates the second precoder to be applied over layer (v1, . . . , v−1), where v1 is the number of layers transmitted via the first UE panel (i.e., the first panel 225-1), v is the total number of layers of the one CW, via both panels (i.e., the first panel 225-1 and the second panel 225-2).

In some embodiments, if the third information indicates that the uplink transmission is the NCJT transmission and the uplink transmission is transmitted with a first codeword and a second codeword, the first TPMI indicates a first precoder to be applied over at least one layer, and the second TPMI indicates a second precoder to be applied over at least one further layer. In particular, the number of the at least one layer corresponds to the first codeword and the number of the at least one further layer corresponds to the second codeword.

In one specific example embodiments, the first TPMI indicates the first precoder to be applied over layers (0, . . . , v1−1), and the second TPMI indicates the second precoder to be applied over layers (0, . . . , v2-1), where v1 is the number of layers of the first CW and v2 is the number of layers of the second CW.

In some embodiments, if the transmission mode is SDM, the network device 210 determines the per port group. Accordingly, in some embodiments, if the third information indicates that the uplink transmission is a SDM transmission, the DCI message comprises first information and second information, where the first information comprises a third SRI associated with the third SRS resource set, and the second information comprises a first TPMI corresponding to a first port group of the third SRS resource set and a second TPMI corresponding to a second port group of the third SRS resource set.

The determination of the number of the first port group and the number of the second port group is similar with that as discussed with regards to the NCJT scenario. Merely for brevity, the same or similar descriptions are omitted here.

In one specific example embodiments, the first TPMI indicates the first precoder to be applied over layers (0, . . . , v1−1), and the second TPMI indicates the second precoder to be applied over layer (v1, . . . , v−1), where v1 is the number of layers transmitted via the first UE panel (i.e., the first panel 225-1), v is the total number of layers of the one CW via both panels (i.e., the first panel 225-1 and the second panel 225-2).

In some embodiments, if the third information indicates that the uplink transmission is the SDM repetition, a number of layers associated with the first TPMI is the same with a number of layers associated with the second TPMI.

In one specific example embodiments, in case that the third SRS resource set corresponds to a 4-port SRS resources, and each of the first and second port groups comprises 2-port resources, the first TPMI associated with the first port group (i.e., 2-port) and second TPMI associated with the second port group (i.e., a further 2-port).

Additionally, in some embodiments, for SDM repetition (such as, PUSCH repetition type A or PUSCH repetition type B), the first port group and the second port group are applied simultaneously for K repetitions with all K consecutive slots (type A), or K nominal repetitions (type B).

In some embodiment, if the transmission mode is NCJT or SDM, or if the DCI message comprises two TPMIs (e.g., the first TPMI and the second TPMI) and one SRI (e.g., the third SRI), the number of ports associated with the first TPMI corresponds to the number of ports in the first group of ports of the SRS resource associated the third SRI, and the number of ports associated with the second TPMI corresponds to the number of ports in the second group of ports of the SRS resource associated the third SRI.

In some embodiment, if the transmission mode is NCJT or SDM, or if the DCI message comprises two TPMIs (e.g., the first TPMI and the second TPMI) and one SRI (e.g., the third SRI), at least one of following maxRank values may be configured for PUSCH transmission: a first value of maxRank associated with the first TPMI (e.g., r1), a second value of maxRank associated with the second TPMI (e.g., r2), a third value of maxRank associated with both the first and second TPMIs (e.g., r, where r=r1+r2). In some embodiment, only the third value of maxRank is configured, while the first value of maxRank associated with the first TPMI is ceil(r/2) (or floor(r/2)), and the second value of maxRank associated with the second TPMI is floor(r/2) (or ceil(r/2)) accordingly. The first, second and third of maxRank values may be determined based on UE capabilities, such as, determined to be the maximum supported SRS port number or maximum supported uplink layers for the first panel 225-1, the second panel 225-1 and both the first and second panels 225, respectively. In addition, the same maxRank value is associated with the first TPMI and the second TPMI.

In some embodiment, if the transmission mode is NCJT or SDM, or if the DCI message comprises two TPMIs (e.g., the first TPMI and the second TPMI) and one SRI (e.g., the third SRI), at least one of the following codebookSubset values may be configured for PUSCH transmission: a first codebookSubset value associated with the first TPMI, a second codebookSubset value associated with the second TPMI, a third codebookSubset value associated with both the first and the second TPMIs. The first, the second and the third codebookSubset values may be determined based on the UE capabilities, such as determined to be the coherent type for the first panel 225-1, the second panel 225-2 and both the first and second panels 225, respectively. The value of codebookSubset can be one of the following: fullAndPartialAndNonCoherent, partialAndNonCoherent, nonCoherent. In addition, the same codebookSubset value is associated with the first TPMI and the second TPMI.

In some embodiment, if the transmission mode is NCJT or SDM, or if the DCI message comprises two TPMIs (e.g., the first TPMI and the second TPMI) and one SRI (e.g., the third SRI), at least one of the following fullpowermode values may be configured for PUSCH transmission: a first fullpowermode value associated with the first TPMI, a second fullpowermode value associated with the second TPMI, a third fullpowermode value associated with both the first and the second TPMIs, the fourth fullpowermode value applied between the first and the second TPMIs. The first, the second and the third fullpowermode value may be determined based on the UE capabilities, such as, determined to be the full power mode within the first panel 225-1, within the second panel 225-2, and within each panel 225, respectively. The fourth fullpowermode value is determined based on the UE capability, such as, determined to be the panel-level full power mode. Any of the first, the second and the third fullpowermode values can be one the following: port-level fullpowermode0, port-level fullpowermode1, port-level fullpowermode2. The fourth fullpowermode value can be one of the following: panel-level fullpowermode0, panel-level fullpowermode1, panel-level fullpowermode2. In addition, the same fullpowermode value is associated with the first TPMI and the second TPMI.

In some embodiments, if the third information indicates that the uplink transmission is a CJT transmission, The DCI message comprises first information and second information, where the first information comprises a third SRI associated with the third SRS resource set, and the second information comprises a third TPMI corresponding to the third SRI.

In some embodiment, if the transmission mode is CJT, or if the DCI message comprises one TPMI (e.g., the third TPMI) and one SRI (e.g., the third SRI), the maxRank value configured for PUSCH transmission may be a fourth value of maxRank associated with the third TPMI. The fourth value of maxRank is determine based on UE capability, such as, determined to be the maximum supported SRS port number or maximum supported UL layers for both the first and second panels 225.

In some embodiment, if the transmission mode is CJT, or if the DCI message comprises one TPMI (e.g., the third TPMI) and one SRI (e.g., the third SRI), the codebookSubset value configured for PUSCH transmission may be a fourth codebookSubset value associated with the third TPMI. The fourth codebookSubset value is determined based on the UE capability, such as, determined to be the coherent type for both the first and second panels 225. The value of codebookSubset can be: fullAndPartialAndNonCoherent.

In some embodiment, if the transmission mode is CJT, or if the DCI message comprises one TPMI (e.g., the third TPMI) and one SRI (e.g., the third SRI), at least one of the following fullpowermode values may be configured for PUSCH transmission: a fifth fullpowermode value and a sixth fullpowermode associated with the third TPMI The fifth fullpowermode value is determined based on the UE capability, such as, determined to be the full power mode within each panel. The sixth fullpowermode value may be based on the UE capability, such as, determined to be on panel-level full power mode. The fifth fullpowermode can be one the following: port-level fullpowermode0, port-level fullpowermode1, port-level fullpowermode2. The sixth fullpowermode value can be one of the following: panel-level fullpowermode0, panel-level fullpowermode1, panel-level fullpowermode2.

It is to be understood that the DCI message may optionally reserve some codepoints for other scenario, depending on the bitwidth of related field (i.e., the third information).

### Example Processes Associated With Two SRS Resource Sets

In some embodiments, there is no newly-introduced SRS resource set (with ‘usage’=‘codebook’) dedicatedly configured for the PUSCH STxMP.

In some embodiments, the terminal device 220 receives a third SRS configuration indicating:
a first SRS resource set associated with a first panel or a first capability value set of the terminal device 220,
a second SRS resource set associated with a second panel or a second capability value set of the terminal device 220.

Additionally, in some embodiments, resources comprised in the first and the second first SRS resource sets are supported to be used simultaneously, such that the number of layers and the precoders for PUSCH STxMP may be determined thereby.

Alternatively, in some other embodiments, if ideal isolation is assumed (i.e., UE transmission across panels are not interfering each other), from each TRP perspective, the two SRS resources can be transmitted in different time domain location. In view of this, the concept of simultaneous transmission of the two SRS resources can be relaxed, such as the transmissions of the two SRS resources are performed within a time window.

As one specific example embodiments, as for the terminal device 220 equipped with two 2-port panels and can use one or both for uplink transmission to 2 TRPs. In this specific example embodiment, the first SRS set corresponds to the first panel 225-1 and the second SRS set corresponds to the second panel 225-2. In this specific example embodiment, multiple 2-port SRS transmissions are performed, and a 4-port TPMI may be determined thereby (especially for the CJT STxMP mode). Further, in this specific example embodiment, the first 2-port SRS resource (corresponding to the first SRS set) is transmitted with port {0, 1} and the second 2-port SRS resource (corresponding to the second SRS set) is transmitted with ports with port ID offset, e.g., port{2, 3}.

Accordingly, in some embodiments, the DCI message comprises first information and second information, where the first information comprises a first SRI associated with the first SRS resource set and a second SRI associated with the second SRS resource set, and the second information comprises at least one TPMI associated with a transmission precoder selected from an uplink codebook. In particular, the transmission precoder has a number of ports corresponding to a sum of number of ports which as associates with the first and second SRIs.

In some embodiment, in case of NCJT transmission, the total rank is determined by a first rank obtained with of the first SRS resource set and a second rank obtained with the second SRS set. Accordingly, in some embodiments, if the third information indicates that the uplink transmission is a NCJT transmission, the DCI message comprises first information and second information, where the first information comprises a first SRI associated with the first SRS resource set and a second SRI associated with the second SRS resource set, while the second information comprises a first TPMI corresponding to the first SRI and a second TPMI corresponding to the second SRI.

In some embodiments, if the third information indicates that the uplink transmission is the NCJT transmission and the uplink transmission is transmitted with one codeword, the first TPMI indicates a first precoder to be applied over at least one layer and the second TPMI indicates a second precoder to be applied over at least one further layer. In particular, a total number of layers of the first and second precoders equals to a number of layers corresponds to the one codeword.

In one specific example embodiments, the first TPMI indicates the first precoder to be applied over layers (0, . . . , v1−1) which corresponds to the first SRI, and the second TPMI indicates the second precoder to be applied over layer (v1, . . . , v−1) which corresponds to the second SRI, where v1 is the number of layers transmitted via the first UE panel (i.e., the first panel 225-1), v is the total number of layers of the one CW, via both panels (i.e., the first panel 225-1 and the second panel 225-2).

In some embodiments, if the third information indicates that the uplink transmission is the NCJT transmission and the uplink transmission is transmitted with a first codeword and a second codeword, the first TPMI indicates a first precoder to be applied over at least one layer, the number of the at least one layer corresponds to the first codeword, and the second TPMI indicates a second precoder to be applied over at least one further layer. In particular, the number of the at least one further layer corresponds to the second codeword.

In one specific example embodiments, the first TPMI indicates the first precoder to be applied over layers (0, . . . , v1−1) which corresponds to the first SRI, and the second TPMI indicates the second precoder to be applied over layers (0, . . . , v2-1) which corresponds to the second SRI, where v1 is the number of layers of the first CW and v2 is the number of layers of the second CW.

Additionally, in some embodiments, in case that there are two CWs (i.e., TBs), the DCI message comprise two modulation and coding scheme (MCS)/redundancy versions (RV)/new data indicators (NDI) fields. In view of this, whether one CW or two CWs is applied can be determined by a number of MCS/RV/NDI fields.

In some embodiment, in case of SDM transmission, the suitable rank is determined to be min (a first rank obtained with of the first SRS resource set, a second rank obtained with the second SRS set). Accordingly, in some embodiments, if the third information indicates that the uplink transmission is a NCJT transmission, the DCI message comprises first information and second information, where the first information comprises a first SRI associated with the first SRS resource set and a second SRI associated with the second SRS resource set, while the second information comprises a first TPMI corresponding to the first SRI and a second TPMI corresponding to the second SRI.

In some embodiments, if the third information indicates that the uplink transmission is the SDM repetition, a number of layers associated with the first TPMI is the same with a number of layers associated with the second TPMI.

Additionally, in some embodiments, for SDM repetition (such as, PUSCH repetition type A or PUSCH repetition type B), the first port group and the second port group are applied simultaneously for K repetitions with all K consecutive slots (type A), or K nominal repetitions (type B).

In some embodiment, if the transmission mode is NCJT or SDM, or if the DCI message comprises two TPMIs (e.g., the first TPMI and the second TPMI) and two SRIs (e.g., the first SRI and the second SRI), at least one of following maxRank values may be configured for PUSCH transmission: a first value of maxRank associated with the first TPMI (e.g., r1), the second value of maxRank associated with the second TPMI (e.g., r2), a third value of maxRank associated with both the first and second TPMIs (e.g., r, where r=r1+r2). In some embodiment, only the third value of maxRank is configured, while the first value of maxRank associated with the first TPMI is ceil(r/2) (or floor(r/2)), and the second value of maxRank associated with the second TPMI is floor(r/2) (or ceil(r/2)) accordingly. The first, second and third of maxRank values may be determined based on UE capabilities, such as, determined to be the maximum supported SRS port number or maximum supported uplink layers for the first panel 225-1, the second panel 225-2 and both the first and second panels 225, respectively.

In some embodiment, if the transmission mode is NCJT or SDM, or if the DCI message comprises two TPMIs (e.g., the first TPMI and the second TPMI) and two SRIs (e.g., the first SRI and the second SRI), at least one of the following codebookSubset values may be configured for PUSCH transmission: a first codebookSubset value associated with the first TPMI, a second codebookSubset value associated with the second TPMI, a third codebookSubset value associated with both the first and the second TPMIs. The first, the second and the third codebookSubset values may be determined based on the UE capabilities, such as, determined to be the coherent type for the first panel 225-1, the second panel 225-1 and both the first and second panels 225, respectively. The value of codebookSubset can be one of the following: fullAndPartialAndNonCoherent, partialAndNonCoherent, nonCoherent.

In some embodiment, if the transmission mode is NCJT or SDM, or if the DCI message comprises two TPMIs (e.g., the first TPMI and the second TPMI) and two SRIs (e.g., the first SRI and the second SRI), at least one of the following fullpowermode values may be configured for PUSCH transmission: a first fullpowermode value associated with the first TPMI, a second fullpowermode value associated with the second TPMI, a third fullpowermode value associated with both the first and the second TPMIs, a fourth fullpowermode value applied between the first and the second TPMIs. The first, the second and the third fullpowermode values may be determined based on the UE capabilities, such as, determined to be the full power mode within the first panel 225-1, within the second panel 225-1, and within each panel 225, respectively. The fourth fullpowermode value may be determined based on the UE capability, such as, determined to be the panel-level full power mode. Any of the of the first, the second and the third fullpowermode values can be one the following: port-level fullpowermode0, port-level fullpowermode1, port-level fullpowermode2. The fourth fullpowermode value can be one of the following: panel-level fullpowermode0, panel-level fullpowermode1, panel-level fullpowermode2.

In some embodiment, in case of CJT transmission, the total rank can be obtained by the network device 210 by joint measurement of a plurality of SRS resources (such as, the first and second SRS resource sets). Accordingly, in some embodiments, if the third information indicates that the uplink transmission is a CJT transmission, the DCI message comprises first information and second information, where the first information comprises a first SRI associated with the first SRS resource set and a second SRI associated with the second SRS resource set, while the second information comprises a fourth TPMI associated with the first SRI and second SRI. Alternatively, in some embodiment, if the third information indicates that the uplink transmission is a CJT transmission, the second information comprises a fifth TPMI and a sixth TPMI jointly associated with the first SRI and second.

In some embodiment, if the transmission mode is CJT, or if the DCI message comprises two SRIs (e.g., the first SRI and the second SRI) and one TPMI (e.g., the fourth TPMI), the number of ports associated with the fourth TPMI corresponds to the sum of the number of ports of the SRS resource associated the first SRI and the number of ports of the SRS resource associated with the second SRI.

In some embodiment, if the transmission mode is CJT, or if the DCI message comprises two SRIs (e.g., the first SRI and the second SRI) and one TPMI (e.g., the fourth TPMI), the maxRank value configured for PUSCH transmission may be a fourth value of maxRank associated with the fourth TPMI. In some embodiment, if the transmission mode is CJT, or if the DCI message comprises two SRIs (e.g., the first SRI and the second SRI) and one TPMI (e.g., the fourth TPMI), the maxRank value associated with the fourth TPMI may be set as two times of the maxRank value configured for PUSCH transmission. The fourth value of maxRank is determined based on UE capability, such as, determine to be the maximum supported SRS port number or maximum supported UL layers for both panels. Alternatively, in some embodiment, if the transmission mode is CJT, the following maxRank values may be configured for PUSCH transmission: a fifth and the sixth values of maxRank associated with the fifth and sixth TPMIs, respectively. The fifth and the sixth values of maxRank are determined based on UE capability, such as, determined to be the maximum supported SRS port number or maximum supported uplink layers for the first panel 225-1 and the second panel 225-2, respectively.

In some embodiment, if the transmission mode is CJT, or if the DCI message comprises two SRIs (e.g., the first SRI and the second SRI) and one TPMI (e.g., the fourth TPMI), the codebookSubset value configured for PUSCH transmission may be a fourth codebookSubset value associated with the fourth TPMI. The fourth codebookSubset value is determined based on the UE capability, such as, determined to be the coherent type for both the first and second panels 225. The value of codebookSubset can be: fullAndPartialAndNonCoherent. Alternatively, in some embodiment, if the transmission mode is CJT, the following codebookSubset values may be configured for PUSCH transmission: a fifth and sixth codebookSubset values associated with the fifth and sixth TPMIs, respectively. The fifth and sixth codebookSubset values are determined based on the UE capability, such as, determined to be the coherent type for the first and the second panel respectively. The value of codebookSubset can be: fullAndPartialAndNonCoherent.

In some embodiment, if the transmission mode is CJT, at least one of the following fullpowermode values may be configured for PUSCH transmission: a fifth fullpowermode value and a sixth fullpowermode associated with the fourth TPMI, or the fifth and the sixth TPMIs. The fifth fullpowermode value is determined based on the UE capability, such as, determined to be the full power mode within each panel. The sixth fullpowermode value is determined based on the UE capability, such as, determined to be the panel-level full power mode. The fifth fullpowermode value can be one the following: port-level fullpowermode0, port-level fullpowermode1, port-level fullpowermode2. The sixth fullpowermode value can be one of the following: panel-level fullpowermode0, panel-level fullpowermode1, panel-level fullpowermode2.

It is to be understood that the DCI message may optionally reserve some codepoints for other scenario, depending on the bitwidth of related field (i.e., the third information).

### Example Processes for Scaling the Transmit Power

According to some embodiments of the present disclosure, the processed for scaling the transmit power is enhanced. Still refer to FIG. 3, the terminal device 220 may control 360 the transmit power before a PUSCH transmission.

Specifically, the terminal device 220 transmits full power transmission capability information to the network device 210, where the full power transmission capability indicating a panel-level full power transmission capability and a port-level full power transmission capability within a panel. Then, the terminal device 220 receives a configuration (such as, a DCI message) for an uplink transmission from the network device 210, where the configuration indicates a TPMI or TPMI combination. Based on the full power transmission capability information and the indicated TPMI or TPMI combination, the terminal device 220 may controls the transmit power of the uplink transmission.

In this way, a per-UE and per-panel power constraint is enabled. Further, the terminal device 220 may report multiple values for the maximum number of SRS ports via capability value set reporting.

In some embodiments, the terminal device 220 scales the transmit power with a first scaling factor (represented as s′) and the a second scaling factor (represented as s), where the first scaling factor is calculated at least in part based on the panel-level full power transmission capability, and the second scaling factor is calculated at least in part based on the port-level full power transmission capability within a panel.

In some embodiments, the first scaling factor ‘s′’ is 1, or, a first ratio of a number of panels with non-zero PUSCH transmission power over the maximum number of panels supported/activated by the terminal device 220. Specifically, the first scaling factor s′ is 1, or, the first ratio, depends on panel-level full power mode configured and supported by the terminal device 220.

In some embodiments, the second scaling factor ‘s’ is 1, or, a second ratio of a number of antenna ports with non-zero PUSCH transmission power over the maximum number of SRS ports supported by the UE in one SRS resource per panel. Specifically, the second scaling factor s is 1, or the second ratio, depends on port-level full power mode configured and supported by the UE.

In some embodiments, the first scaling factor is calculated based on at least one of the following:
the panel-level full power transmission capability,
a TPMI or TPMI combination configured for the uplink transmission,
a number of panels used for the uplink transmission,
a number of activated panels of the terminal device 220,
a number of panels corresponding to the TMPT or the TPMI combination, or
a total number of panels of the terminal device 220.

In some embodiments, the second scaling factor is calculated based on at least one of the following:
the port-level full power transmission capability,
a TPMI or TPMI combination configured for the uplink transmission,
a number of ports used for the uplink transmission within a panel,
a number of activated ports within a panel,
a number of ports corresponding to the TPMI or the TPMI combination, or
a total number of ports within the panel.

In one specific example embodiment, the terminal device 220 reports multiple values for the maximum number of SRS ports via capability value set reporting, for example, 2-port SRS for the first panel 225-1 and the second panel 225-2, 4-port SRS for an STxMP.

The terminal device 220 calculates the transmit power P and the linear value of the transmit power \hat{P}.

In this specific example embodiment, the terminal device 220 scales the linear value by the second scaling factor s within a specific panel, i.e., s\hat{P}, specifically,
If fullpowermode 0 is assumed, s=1;
If fullpowermode1 is assumed, s=number of non-zero ports/number of SRS ports per panel, for example, if for panel 1, only 1 port is non-zero, then s=1/2, not 1/4 as calculated with legacy method;
If fullpowermode2 is assumed, s=1 for reported TPMI/TPMI combination, for the remaining TPMI/TPMI combination, s=number of non-zero ports/number of SRS ports per panel, for example, if for panel 1, only 1 port is non-zero, then s=1/2, not 1/4 as calculated with legacy method.

Further, in this specific example embodiment, the terminal device 220 scales the linear value by a second factor s′ across multiple panels, i.e., in total s′s\hat{P}, specifically,
If panel-level fullpowermode 0 is assumed, s′=1, which means that the terminal device 220 can always deliver the maximum output even with a subset of panels are used for transmission;
If panel-level fullpowermode1 is assumed, s′=number of panels used for transmission/number of total panels, for example, if non-zero PUSCH layers is transmitted with only antenna ports associated with panel 1, s′=1/2;
If panel-level fullpowermode2 is assumed, s′=1 for reported TPMI/TPMI combination, for the remaining TPMI/TPMI combination, s′=number of panels used for transmission/number of total panels.

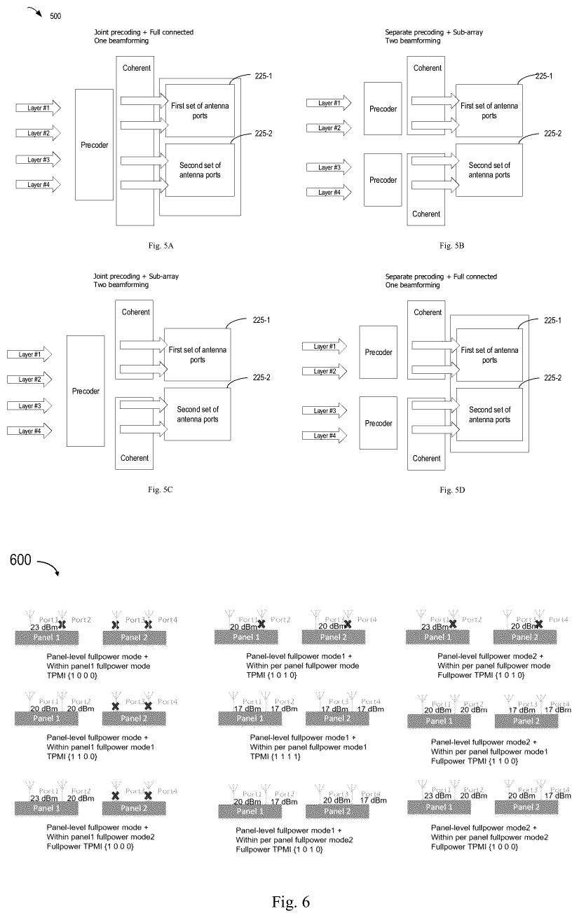

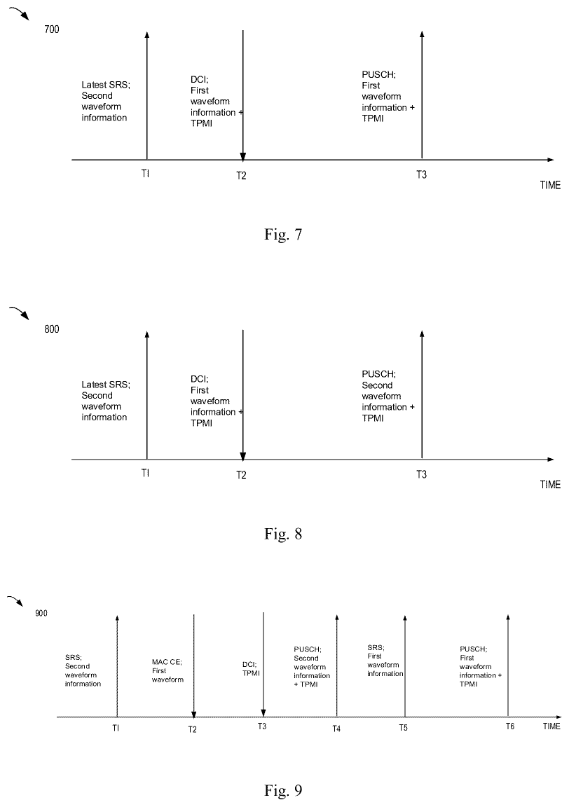

For better understanding, reference is now made to FIG. 6, which illustrates examples 600 of controlling transmit power. In the specific example of FIG. 6, the maximum transmit power is 23 dBm and a 4-port 1 layer transmission is performed. FIG. 6 illustrates the different combinations of panel-level fullpowermode and per panel fullpowermode that can deliver maximum transmit power.

In some embodiments, for a single-panel, or panel-transparent uplink transmission, if ul-FullPowerTransmission in PUSCH-Config is provided, the UE scales P\hat{ }_(“PUSCH”,b,f,c) (i,j,q_d,l) by s where:
if ul-FullPowerTransmission in PUSCH-Config is set to fullpowerMode1, and each SRS resource in the SRS-ResourceSet with usage set to ‘codebook’ has more than one SRS port, s is the ratio of a number of antenna ports with non-zero PUSCH transmission power over the maximum number of SRS ports supported by the UE in one SRS resource associated with the corresponding capability value set reporting
if ul-FullPowerTransmission in PUSCH-Config is set to fullpowerMode2,
   s=1 for full power TPMIs reported by the terminal device 220, and s is the ratio of a number of antenna ports with non-zero PUSCH transmission power over a number of SRS ports for remaining TPMIs, where the number of SRS ports is associated with an SRS resource indicated by an SRI field in a DCI format scheduling the PUSCH transmission if more than one SRS resource associated with the corresponding capability value set reporting is configured in the SRS-ResourceSet with usage set to ‘codebook’, or indicated by Type 1 configured grant, or the number of SRS ports is associated with the SRS resource associated with the corresponding capability value set reporting if only one SRS resource is configured in the SRS-ResourceSet with usage set to ‘codebook’,
   s=1, if an SRS resource with a single port is indicated by an SRI field in a DCI format scheduling the PUSCH transmission when more than one SRS resource is provided in the SRS-ResourceSet with usage set to ‘codebook’, or indicated by Type 1 configured grant, or if only one SRS resource with a single port is provided in the SRS-ResourceSet with usage set to ‘codebook’, and
   if ul-FullPowerTransmission in PUSCH-Config is set to fullpower, s=1

Else, if each SRS resource in the SRS-ResourceSet with usage set to ‘codebook’ has more than one SRS port, the terminal device 220 scales the linear value by the ratio of the number of antenna ports with a non-zero PUSCH transmission power to the maximum number of SRS ports supported by the terminal device 220 in one SRS resource.

Example processes for Dynamic Waveform Switch

According to some example embodiments of the present disclosure, the dynamical waveform switch is enabled. In some embodiments, the waveform may be a single carrier waveform or multi-carrier waveform. In view of this, the waveform switch refers to a switch between the single carrier waveform and multi-carrier waveform, Further, the transform precoding enabled means a single carrier waveform (in new radio, NR, it is discrete fourier transform spreading orthogonal frequency division multiplexing, DFT-s-OFDM) accordingly, transform precoding disabled means multi-carrier waveform (in NR, it is cyclic prefix orthogonal frequency-division multiplexing, CP-OFDM).

Still refer to FIG. 3, the terminal device 220 receives 370 transmission information from the network device 210. In particular, the transmission information comprises first waveform information and second waveform information, where the first waveform information is to be used by the terminal device 220 for performing an uplink transmission and the second waveform information was used by the terminal device 220 when performing a latest SRS transmission. In some embodiments, the first waveform information is comprised in a DCI message or a MAC CE message. Additionally, the transmission information further comprises precoding information to be used by the terminal device 220 for performing an uplink transmission. Next, the terminal device 220 determines a TPMI or TPMI combination based on the transmission information.

In some embodiments, the first waveform information is indicated explicitly. Specifically, an additional field is comprised in the DCI message to indicate whether the transform precoding is enabled or disabled.

In one specific embodiment, the first waveform information is a first indication indicates whether a first waveform or a second waveform is enabled. For example, a field ‘transform precoding indication’ with 1-bit is introduced, where ‘0’ refers to enabled, and ‘1’ refers to disabled, respectively.

Alternatively, in a further specific embodiment, the first waveform information is a second indication indicates whether to switch a currently applied waveform. For example, a field ‘transform precoding indication’ with 1-bit is introduced, where ‘0’ refers to no-change and ‘1’ refers to a change of waveform, respectively.

Alternatively, the first waveform information is information about a panel or a capability value set of the terminal device 220, the panel or the capability value set corresponding to a specific waveform. For example, a field is ‘transform precoding indication’ with m-bit is introduced, where m-th bit refers to the m-th UE panel/m-th TRP.

Additionally, the dynamic switch of uplink waveform is only applied for some specific scenarios, for example, at least one indicated TPMI/TPMI combination satisfies the following conditions: single-layer transmission using 4 antenna ports, and the TPMI index is one of the following value (12, 14, 17, 19, 20, 22, 25, 27). Below Tables 2 and 3 illustrate two examples for single-layer transmission using 4 antenna ports with first waveform manner and second waveform manner.

TABLE 2
example for single-layer transmission using 4 antenna ports with first waveform manner

| TPMI | W | | | | | | | |
|---|---|---|---|---|---|---|---|---|
| index | (ordered from left to right in increasing order of TPMI index) | | | | | | | |
| 0-7 | $\frac{1}{2} [ \begin{matrix}1 \\ 0 \\ 0 \\ 0\end{matrix} ]$ | $\frac{1}{2} [ \begin{matrix}0 \\ 1 \\ 0 \\ 0\end{matrix} ]$ | $\frac{1}{2} [ \begin{matrix}0 \\ 0 \\ 1 \\ 0\end{matrix} ]$ | $\frac{1}{2} [ \begin{matrix}0 \\ 0 \\ 0 \\ 1\end{matrix} ]$ | $\frac{1}{2} [ \begin{matrix}1 \\ 0 \\ 1 \\ 0\end{matrix} ]$ | $\frac{1}{2} [ \begin{matrix}1 \\ 0 \\ - 1 \\ 0\end{matrix} ]$ | $\frac{1}{2} [ \begin{matrix}1 \\ 0 \\ j \\ 0\end{matrix} ]$ | $\frac{1}{2} [ \begin{matrix}1 \\ 0 \\ - j \\ 0\end{matrix} ]$ |
| 8-15 | $\frac{1}{2} [ \begin{matrix}0 \\ 1 \\ 0 \\ 1\end{matrix} ]$ | $\frac{1}{2} [ \begin{matrix}0 \\ 1 \\ 0 \\ - 1\end{matrix} ]$ | $\frac{1}{2} [ \begin{matrix}0 \\ 1 \\ 0 \\ j\end{matrix} ]$ | $\frac{1}{2} [ \begin{matrix}0 \\ 1 \\ 0 \\ - j\end{matrix} ]$ | $\frac{1}{2} [ \begin{matrix}1 \\ 1 \\ 1 \\ - 1\end{matrix} ]$ | $\frac{1}{2} [ \begin{matrix}1 \\ 1 \\ j \\ j\end{matrix} ]$ | $\frac{1}{2} [ \begin{matrix}1 \\ 1 \\ - 1 \\ 1\end{matrix} ]$ | $\frac{1}{2} [ \begin{matrix}1 \\ 1 \\ - j \\ - j\end{matrix} ]$ |
| 16-23 | $\frac{1}{2} [ \begin{matrix}1 \\ j \\ 1 \\ j\end{matrix} ]$ | $\frac{1}{2} [ \begin{matrix}1 \\ j \\ j \\ 1\end{matrix} ]$ | $\frac{1}{2} [ \begin{matrix}1 \\ j \\ - 1 \\ - j\end{matrix} ]$ | $\frac{1}{2} [ \begin{matrix}1 \\ j \\ - j \\ - 1\end{matrix} ]$ | $\frac{1}{2} [ \begin{matrix}1 \\ - 1 \\ 1 \\ 1\end{matrix} ]$ | $\frac{1}{2} [ \begin{matrix}1 \\ - 1 \\ j \\ - j\end{matrix} ]$ | $\frac{1}{2} [ \begin{matrix}1 \\ - 1 \\ - 1 \\ - 1\end{matrix} ]$ | $\frac{1}{2} [ \begin{matrix}1 \\ - 1 \\ - j \\ j\end{matrix} ]$ |
| 24-27 | $\frac{1}{2} [ \begin{matrix}1 \\ - j \\ 1 \\ - j\end{matrix} ]$ | $\frac{1}{2} [ \begin{matrix}1 \\ - j \\ j \\ - 1\end{matrix} ]$ | $\frac{1}{2} [ \begin{matrix}1 \\ - j \\ - 1 \\ j\end{matrix} ]$ | $\frac{1}{2} [ \begin{matrix}1 \\ - j \\ - j \\ 1\end{matrix} ]$ | — | — | — | — |

TABLE 3
example for single-layer transmission using 4 antenna ports with second waveform manner

| TPMI | W | | | | | | | |
|---|---|---|---|---|---|---|---|---|
| index | (ordered from left to right in increasing order of TPMI index) | | | | | | | |
| 0-7 | $\frac{1}{2} [ \begin{matrix}1 \\ 0 \\ 0 \\ 0\end{matrix} ]$ | $\frac{1}{2} [ \begin{matrix}0 \\ 1 \\ 0 \\ 0\end{matrix} ]$ | $\frac{1}{2} [ \begin{matrix}0 \\ 0 \\ 1 \\ 0\end{matrix} ]$ | $\frac{1}{2} [ \begin{matrix}0 \\ 0 \\ 0 \\ 1\end{matrix} ]$ | $\frac{1}{2} [ \begin{matrix}1 \\ 0 \\ 1 \\ 0\end{matrix} ]$ | $\frac{1}{2} [ \begin{matrix}1 \\ 0 \\ - 1 \\ 0\end{matrix} ]$ | $\frac{1}{2} [ \begin{matrix}1 \\ 0 \\ j \\ 0\end{matrix} ]$ | $\frac{1}{2} [ \begin{matrix}1 \\ 0 \\ - j \\ 0\end{matrix} ]$ |
| 8-15 | $\frac{1}{2} [ \begin{matrix}0 \\ 1 \\ 0 \\ 1\end{matrix} ]$ | $\frac{1}{2} [ \begin{matrix}0 \\ 1 \\ 0 \\ - 1\end{matrix} ]$ | $\frac{1}{2} [ \begin{matrix}0 \\ 1 \\ 0 \\ j\end{matrix} ]$ | $\frac{1}{2} [ \begin{matrix}0 \\ 1 \\ 0 \\ - j\end{matrix} ]$ | $\frac{1}{2} [ \begin{matrix}1 \\ 1 \\ 1 \\ 1\end{matrix} ]$ | $\frac{1}{2} [ \begin{matrix}1 \\ 1 \\ j \\ j\end{matrix} ]$ | $\frac{1}{2} [ \begin{matrix}1 \\ 1 \\ - 1 \\ - 1\end{matrix} ]$ | $\frac{1}{2} [ \begin{matrix}1 \\ 1 \\ - j \\ - j\end{matrix} ]$ |
| 16-23 | $\frac{1}{2} [ \begin{matrix}1 \\ j \\ 1 \\ j\end{matrix} ]$ | $\frac{1}{2} [ \begin{matrix}1 \\ j \\ j \\ - 1\end{matrix} ]$ | $\frac{1}{2} [ \begin{matrix}1 \\ j \\ - 1 \\ - j\end{matrix} ]$ | $\frac{1}{2} [ \begin{matrix}1 \\ j \\ - j \\ 1\end{matrix} ]$ | $\frac{1}{2} [ \begin{matrix}1 \\ - 1 \\ 1 \\ - 1\end{matrix} ]$ | $\frac{1}{2} [ \begin{matrix}1 \\ - 1 \\ j \\ - j\end{matrix} ]$ | $\frac{1}{2} [ \begin{matrix}1 \\ - 1 \\ - 1 \\ 1\end{matrix} ]$ | $\frac{1}{2} [ \begin{matrix}1 \\ - 1 \\ - j \\ j\end{matrix} ]$ |
| 24-27 | $\frac{1}{2} [ \begin{matrix}1 \\ - j \\ 1 \\ - j\end{matrix} ]$ | $\frac{1}{2} [ \begin{matrix}1 \\ - j \\ j \\ 1\end{matrix} ]$ | $\frac{1}{2} [ \begin{matrix}1 \\ - j \\ - 1 \\ j\end{matrix} ]$ | $\frac{1}{2} [ \begin{matrix}1 \\ - j \\ - j \\ - 1\end{matrix} ]$ | — | — | — | — |

In some embodiments, if the first waveform information and the precoding information are indicated by the DCI message, the terminal device 220 determines the TPMI or TPMI combination based on the first waveform information and the precoding information indicated by the DCI message. FIG. 7 illustrates a timing 700, where the TPMI or TPMI combination based on the first waveform information and the precoding information indicated by the DCI message.

Alternatively, if the first waveform information and the precoding information are indicated by the DCI message, the terminal device 220 determines the TPMI or TPMI combination based on the precoding information indicated by the DCI message and the second waveform information. FIG. 8 illustrates a timing 800, where the TPMI or TPMI combination based on the precoding information indicated by the DCI message and the second waveform information.

Alternatively, if the first waveform information is indicated by the MAC CE message and the precoding information is indicated by the DCI message, the terminal device 220 determines the TPMI or TPMI combination based on the first waveform information and the precoding information until the first waveform information is used when performing the latest SRS. FIG. 9 illustrates a timing 900, where the TPMI or TPMI combination based on first waveform information is indicated by a MAC CE message.

In addition to an explicit indication, the first waveform information also may be indicated implicitly. Specifically, in some embodiments, first waveform information is indicated by a SRS resource with a first pre-configured correspondence to a specific waveform. As one specific example embodiments, first SRS resources (with ‘usage’=‘codebook’) are corresponding to transform precoding enabled, and second SRS resources are corresponding to for transform precoding disabled. In this event, the SRI comprised in the DCI message implies whether transform precoding is enabled or disabled. Additionally, the TPMI in DCI depends on the indicated SRI.

Alternatively, in some other embodiments, first waveform information is indicates by a SRS resource set with a second pre-configured correspondence to a specific waveform.

As one specific example embodiments, a first SRS resource set and a second SRS resource set are configured with ‘usage’=‘codebook’, where the first SRS resource set is corresponding to transform precoding enabled and the second SRS resource set is corresponding to transform precoding disabled. In this event, the ‘SRS resource set indicator’ in DCI implies whether transform precoding is enabled or disabled. Additionally, the TPMI in the DCI message depends on ‘SRS resource set indicator’ and the ‘SRI’

In some other embodiments, if the first waveform information indicates a waveform switch, the precoding information is not associated a TPMI index which is configured with different precoding matrices in a first codebook for a first waveform and a second codebook of a second waveform. That is, the terminal device 220 does not expect such TPMIs (such as, TPMI with index of any of {12, 14, 17, 19, 20, 22, 25, 27}) indicated together with dynamic waveform switch.

Additionally, in some other embodiments, the uplink transmission is a single-layer transmission using 4 antenna ports and the TPMI index is of the following {12, 14, 17, 19, 20, 22, 25, 27}.

### Example Methods

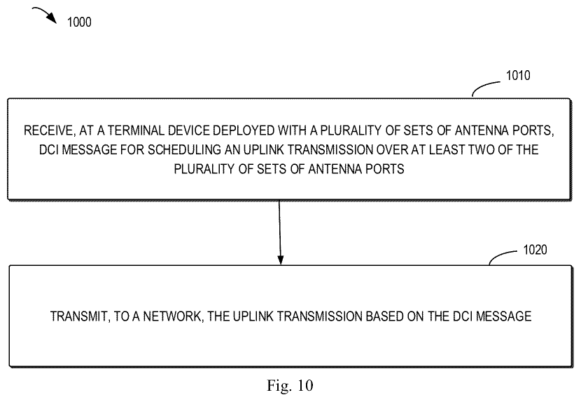

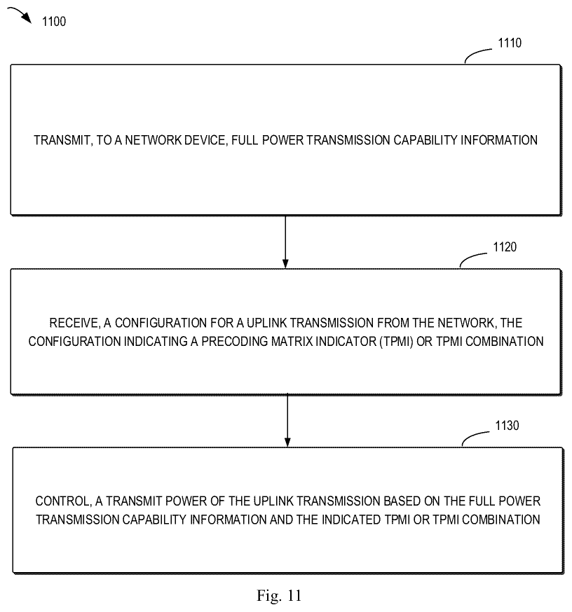

FIG. 10 illustrates a flowchart of an example method 1000 in accordance with some embodiments of the present disclosure. For example, the method 1000 can be implemented at the terminal device 220 as shown in FIGS. 2A to 2C.

At block 1010, the terminal device 220 deployed with a plurality of sets of antenna ports receives a DCI message for scheduling at least one uplink transmission over at least two of the plurality of sets of antenna ports, the DCI message indicating: first information about SRS resources associated with the at least one uplink transmission, second information about the precoding information associated with the at least one uplink transmission; and third information indicating a transmission mode of the at least one uplink transmission.

At block 1020, the terminal device 220 transmits, based on the DCI message, the at least one uplink transmission over the at least two of the plurality of sets of antenna ports to a network.

In some embodiments, the plurality of sets of antenna ports comprise: a first set of antenna port corresponding to a first panel or a first capability value set of the terminal device 220, and a second set of antenna port corresponding to a second panel or a second capability value set of the terminal device 220. Further, the at least one uplink transmission is a CB-based PUSCH and performed via a plurality of TRPs.

In some embodiments, the terminal device 220 receives a first SRS configuration, where the first SRS configuration indicates: a first SRS resource set associated with a first panel or a first capability value set of the terminal device 220, a second SRS resource set associated with a second panel or a second capability value set of the terminal device 220, and a third SRS resource set associated with both the first and second panels or both the first and second capability value sets of the terminal device 220.

In some embodiments, if the third information indicates that the at least one uplink transmission is a SDM repetition or a NCJT transmission, the first information comprises: a first SRI associated with the first SRS resource set, and a second SRI associated with the second SRS resource set; and the second information comprises: a first TPMI corresponding to the first SRI, and a second TPMI corresponding to the second SRI.

In some embodiments, if the third information indicates that the at least one uplink transmission is the SDM repetition, a number of layers associated with the first TPMI is the same with a number of layers associated with the second TPMI.

In some embodiments, if the third information indicates that the at least one uplink transmission is the NCJT transmission and the at least one uplink transmission is transmitted with one codeword, the first TPMI indicates a first precoder to be applied over at least one layer and the second TPMI indicates a second precoder to be applied over at least one further layer. Further, a total number of layers of the first and second precoders equals to a number of layers corresponds to the one codeword.

In some embodiments, if the third information indicates that the at least one uplink transmission is the NCJT transmission and the at least one uplink transmission is transmitted with a first codeword and a second codeword, the first TPMI indicates a first precoder to be applied over at least one layer, the number of the at least one layer corresponds to the first codeword, and the second TPMI indicates a second precoder to be applied over at least one further layer, the number of the at least one further layer corresponds to the second codeword.

In some embodiments, if the third information indicates that the at least one uplink transmission is a CJT transmission, the first information comprises: a third SRI associated with the third SRS resource set, and the second information comprises: a third TPMI corresponding to the third SRI.

In some embodiments, the terminal device 220 receives a second SRS configuration indicating a third SRS resource set associated with both a first panel and a second panel or both a first capability value set and a second capability value set of the terminal device 220.

In some embodiments, the first information comprises: a third SRI associated with the third SRS resource set, and the second information comprises: at least one TPMI associated with at least one transmission precoder selected from an uplink codebook, the at least one transmission precoder having a corresponding number of ports corresponding to the at least one TPMI.

In some embodiments, if the third information indicates that the at least one uplink transmission is a SDM repetition or a NCJT transmission, the at least one TPMI comprises: a first TPMI corresponding to a first port group of the third SRS resource set, and a second TPMI corresponding to a second port group of the third SRS resource set.

In some embodiments, at least one of a number of the first port group and a number of the second port group are determined based on at least one of the following: port group information comprised in the DCI message, a first number of ports corresponding to the first TPMI, a second number of ports corresponding to the second TPMI, a number of ports of SRS resources comprised in the third SRS set, port group information comprised in the second SRS configuration, or capability information corresponding to a first and second control resource set pools of the terminal device 220.

In some embodiments, if the third information indicates that the at least one uplink transmission is a CJT transmission, the second information comprises: a third TPMI corresponding to the third SRI.

In some embodiments, the terminal device 220 receives a third SRS configuration indicating: a first SRS resource set associated with a first panel or a first capability value set of the terminal device 220, and a second SRS resource set associated with a second panel or a second capability value set of the terminal device 220. In particular, resources comprised in the first and the second first SRS resource sets are supported to be used simultaneously.

In some embodiments, the first information comprises: a first SRI associated with the first SRS resource set, and a second SRI associated with the second SRS resource set; and the second information comprises: at least one TPMI associated with a transmission precoder selected from an uplink codebook, the transmission precoder having a number of ports corresponding to a sum of number of ports which associates with the first and second SRIs.

In some embodiments, if the third information indicates that the at least one uplink transmission is a CJT transmission, the at least one TPMI comprises one of the following: a fourth TPMI associated with the first SRI and second SRI, or a fifth TPMI and a sixth TPMI jointly associated with the first SRI and second SRI.

In some embodiments, the terminal device 220 transmits, to the network device 210, transmission capability information over at least two of the plurality of sets of antenna ports, the transmission capability information comprising at least one of the following: a transmission mode associated with a simultaneous transmission with the plurality of sets of antenna ports, a hybrid beamforming type associated with a digital precoding manner and an analog beamforming manner, a first coherence type indicating a panel-level coherence capability, a second coherence type indicating a port-level coherence capability within a panel, a first full power mode indicating a panel-level full power capability, or a second full power mode indicating a port-level full power capability within a panel.

In some embodiments, the terminal device 220 receives a SRS configuration generated based on the transmission capability information.

In some embodiments, the first coherence type, the second coherence type, the first full power mode and the second full power mode are associated with at least one of the following: the transmission mode, the hybrid beamforming type associated with a digital precoding manner and an analog beamforming manner.

In some embodiments, the first coherence type is one of the following: a first panel-level full power mode indicating that a full power is achieved regardless of a number of panels used for the at least one uplink transmission, a second panel-level full power mode indicating that the full power is enabled to be delivered when all panels of the terminal device 220 are used for the at least one uplink transmission, or a third panel-level full power mode indicating that the full power is enabled when all panels of the terminal device 220 are used for the at least one uplink transmission or at least one specific TPMI or TPMI combination is configured.

In some embodiments, if the first full power mode is the third panel-level full power mode, the transmission capability information further comprises information about the at least one specific TPMI or TPMI combination.

FIG. 11 illustrates a flowchart of an example method 1100 in accordance with some embodiments of the present disclosure. For example, the method 1100 can be implemented at the terminal device 220 as shown in FIGS. 2A to 2C.

At block 1110, the terminal device 220 transmits to full power transmission capability information a network, the full power transmission capability information indicating: a panel-level full power transmission capability, and a port-level full power transmission capability within a panel.

At block 1120, the terminal device 220 receives a configuration for at least one uplink transmission from the network, the configuration indicating a TPMI or TPMI combination.

At block 1130, the terminal device 220 controls a transmit power of the at least one uplink transmission based on the full power transmission capability information and the indicated TPMI or TPMI combination.

In some embodiments, the terminal device 220 scales the transmit power with: a first scaling factor calculated at least in part based on the panel-level full power transmission capability, and a second scaling factor calculated at least in part based on the port-level full power transmission capability within a panel.

In some embodiments, the first scaling factor is calculated based on at least one of the following: the panel-level full power transmission capability, a TPMI or TPMI combination configured for the at least one uplink transmission, a number of panels used for the at least one at least one uplink transmission, a number of activated panels of the terminal device 220, a number of panels corresponding to the TMPT or the TPMI combination, or a total number of panels of the terminal device 220.

In some embodiments, the second scaling factor is calculated based on at least one of the following: the port-level full power transmission capability, a TPMI or TPMI combination configured for the at least one uplink transmission, a number of ports used for the at least one uplink transmission within a panel, a number of activated ports within a panel, a number of ports corresponding to the TPMI or the TPMI combination, or a total number of ports within the panel.

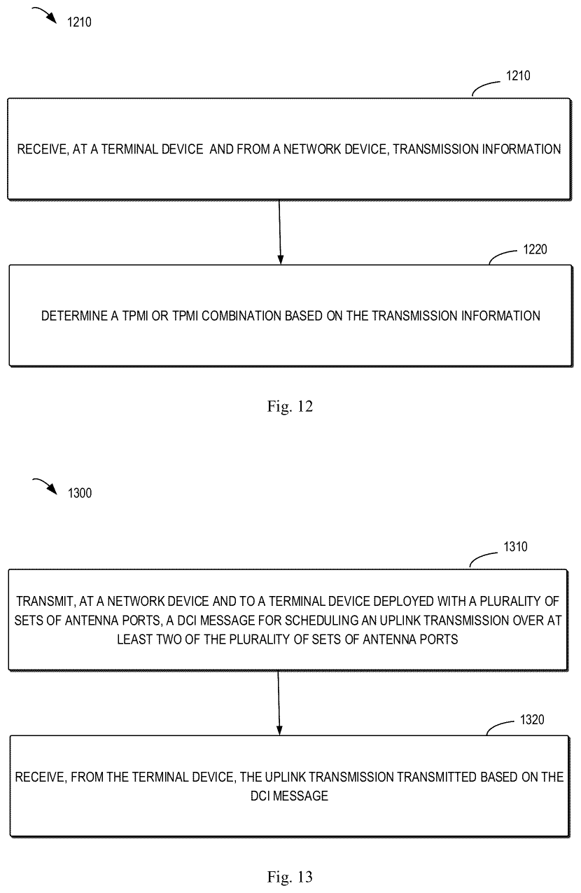

FIG. 12 illustrates a flowchart of an example method 1200 in accordance with some embodiments of the present disclosure. For example, the method 1200 can be implemented at the terminal device 220 as shown in FIGS. 2A to 2C.

At block 1210, the terminal device 220 receives transmission information from a network device 210, the transmission information comprising: first waveform information to be used by the terminal device 220 for performing at least one uplink transmission, the first waveform information being comprised in a DCI message or a MAC CE message, second waveform information used by the terminal device 220 when performing a latest SRS transmission, and precoding information to be used by the terminal device 220 for performing the at least one uplink transmission.

At block 1220, the terminal device 220 determines a TPMI or TPMI combination based on the transmission information.

In some embodiments, the first waveform information is one of the following: a first indication indicates whether a first waveform or a second waveform is enabled, a second indication indicates whether to switch a currently applied waveform, or information about a panel or a capability value set of the terminal device 220, the panel or the capability value set corresponding to a specific waveform.

In some embodiments, if the first waveform information and the precoding information are indicated by the DCI message, the terminal device 220 determines the TPMI or TPMI combination comprises one of: determining the TPMI or TPMI combination based on the first waveform information and the precoding information indicated by the DCI message, or determining the TPMI or TPMI combination based on the precoding information indicated by the DCI message and the second waveform information.

In some embodiments, if the first waveform information is indicated by the MAC CE message and the precoding information is indicated by the DCI message, the terminal device 220 determines the TPMI or TPMI combination comprises: determining the TPMI or TPMI combination based on the first waveform information and the precoding information until the first waveform information is used when performing the latest SRS.

In some embodiments, the first waveform information is indicated by: a SRS resource with a first pre-configured correspondence to a specific waveform, or a SRS resource set with a second pre-configured correspondence to a specific waveform.

In some embodiments, if the first waveform information indicates a waveform switch, the precoding information is not associated a TPMI index which is configured with different precoding matrices in a first codebook for a first waveform and a second codebook of a second waveform.

In some embodiments, the at least one uplink transmission is a single-layer transmission using 4 antenna ports and the TPMI index is one of the following values{12, 14, 17, 19, 20, 22, 25, 27}.

FIG. 13 illustrates a flowchart of an example method 1300 in accordance with some embodiments of the present disclosure. For example, the method 1300 can be implemented at the network device 210 as shown in FIGS. 2A to 2C.

At block 1310, the network device 210 transmits, to a terminal device 220 deployed with a plurality of sets of antenna ports, a DCI message for scheduling at least one uplink transmission over at least two of the plurality of sets of antenna ports, the DCI message indicating: first information about SRS resources associated with the at least one uplink transmission, second information about the precoding information associated with the at least one uplink transmission; and third information indicating a transmission mode of the at least one uplink transmission.

At block 1320, the network device 210 receives, based on the DCI message, the at least one uplink transmission transmitted over the at least two of the plurality of sets of antenna ports from the terminal device 220.

In some embodiments, the plurality of sets of antenna ports comprise: a first set of antenna port corresponding to a first panel or a first capability value set of the terminal device 220, and a second set of antenna port corresponding to a second panel or a second capability value set of the terminal device 220. Further, the at least one uplink transmission is a CB-based PUSCH and performed via a plurality of TRPs.

In some embodiments, the network device 210 transmits a first SRS configuration indicating: a first SRS resource set associated with a first panel or a first capability value set of the terminal device 220, a second SRS resource set associated with a second panel or a second capability value set of the terminal device 220, and a third SRS resource set associated with both the first and second panels or both the first and second capability value sets of the terminal device 220.

In some embodiments, if the third information indicates that the at least one uplink transmission is a SDM repetition or a NCJT transmission, the first information comprises: a first SRI associated with the first SRS resource set, and a second SRI associated with the second SRS resource set; and the second information comprises: a first TPMI corresponding to the first SRI, and a second TPMI corresponding to the second SRI.

In some embodiments, if the third information indicates that the at least one uplink transmission is the SDM repetition, a number of layers associated with the first TPMI is the same with a number of layers associated with the second TPMI.

In some embodiments, if the third information indicates that the at least one uplink transmission is the NCJT transmission and the at least one uplink transmission is transmitted with one codeword, the first TPMI indicates a first precoder to be applied over at least one layer and the second TPMI indicates a second precoder to be applied over at least one further layer. Further, a total number of layers of the first and second precoders equals to a number of layers corresponds to the one codeword.

In some embodiments, if the third information indicates that the at least one uplink transmission is the NCJT transmission and the at least one uplink transmission is transmitted with a first codeword and a second codeword, the first TPMI indicates a first precoder to be applied over at least one layer, the number of the at least one layer corresponds to the first codeword, and the second TPMI indicates a second precoder to be applied over at least one further layer, the number of the at least one further layer corresponds to the second codeword.

In some embodiments, if the third information indicates that the at least one uplink transmission is a CJT transmission, the first information comprises: a third SRI associated with the third SRS resource set, and the second information comprises: a third TPMI corresponding to the third SRI.

In some embodiments, the network device 210 transmits a second SRS configuration indicating a third SRS resource set associated with both a first panel and a second panel or both a first capability value set and a second capability value set of the terminal device 220.

In some embodiments, the first information comprises: a third SRI associated with the third SRS resource set, and the second information comprises: at least one TPMI associated with at least one transmission precoder selected from an uplink codebook, the at least one transmission precoder having a corresponding number of ports corresponding to the at least one TPMI.

In some embodiments, if the third information indicates that the at least one uplink transmission is a SDM repetition or a NCJT transmission, the at least one TPMI comprises: a first TPMI corresponding to a first port group of the third SRS resource set, and a second TPMI corresponding to a second port group of the third SRS resource set.

In some embodiments, at least one of a number of the first port group and a number of the second port group are determined based on at least one of the following: port group information comprised in the DCI message, port group information comprised in the second SRS configuration, a first number of ports corresponding to the first TPMI, a second number of ports corresponding to the second TPMI, a number of ports of SRS resources comprised in the third SRS set, capability information corresponding to a first and second control resource set pools of the terminal device 220, a measured signal quality of each port of the terminal device 220.

In some embodiments, if the third information indicates that the at least one uplink transmission is a CJT transmission, the second information comprises: a third TPMI corresponding to the third SRI.

In some embodiments, the network device 210 transmits a third SRS configuration indicating: a first SRS resource set associated with a first panel or a first capability value set of the terminal device 220, and a second SRS resource set associated with a second panel or a second capability value set of the terminal device 220. Further, resources comprised in the first and the second first SRS resource sets are supported to be used simultaneously.

In some embodiments, the first information comprises: a first SRI associated with the first SRS resource set, and a second SRI associated with the second SRS resource set; and the second information comprises: at least one TPMI associated with a transmission precoder selected from an uplink codebook, the transmission precoder having a number of ports corresponding to a sum of number of ports which associates with the first and second SRIs.

In some embodiments, if the third information indicates that the at least one uplink transmission is a CJT transmission, the at least one TPMI comprises one of the following: a fourth TPMI associated with the first SRI and second SRI, or a fifth TPMI and a sixth TPMI jointly associated with the first SRI and second SRI.

In some embodiments, the network device 210 receives, from the terminal device 220, transmission capability information over at least two of the plurality of sets of antenna ports, the transmission capability information comprising at least one of the following: a transmission mode associated with a simultaneous transmission with the plurality of sets of antenna ports, a hybrid beamforming type associated with a digital precoding manner and an analog beamforming manner, a first coherence type indicating a panel-level coherence capability, a second coherence type indicating a port-level coherence capability within a panel, a first full power mode indicating a panel-level full power capability, or a second full power mode indicating a port-level full power capability within a panel.

In some embodiments, the network device 210 generates a SRS configuration generated based on the transmission capability information and transmits the SRS configuration to the terminal device 220.

In some embodiments, the first coherence type, the second coherence type, the first full power mode and the second full power mode are associated with at least one of the following: the transmission mode, the hybrid beamforming type associated with a digital precoding manner and an analog beamforming manner.

In some embodiments, the first coherence type is one of the following: a first panel-level full power mode indicating that a full power is achieved regardless of a number of panels used for the at least one uplink transmission, a second panel-level full power mode indicating that the full power is enabled to be delivered when all panels of the terminal device 220 are used for the at least one uplink transmission, or a third panel-level full power mode indicating that the full power is enabled when all panels of the terminal device 220 are used for the at least one uplink transmission or at least one specific TPMI or TPMI combination is configured

In some embodiments, if the first full power mode is the third panel-level full power mode, the transmission capability information further comprises information about the at least one specific TPMI or TPMI combination.

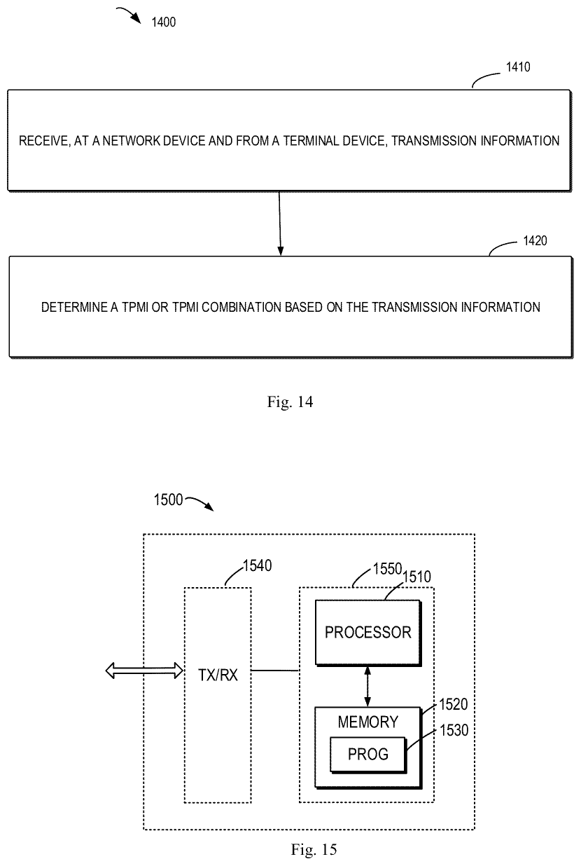

FIG. 14 illustrates a flowchart of an example method 1400 in accordance with some embodiments of the present disclosure. For example, the method 1400 can be implemented at the network device 210 as shown in FIGS. 2A to 2C.

At block 1410, the network device 210 receives transmission information from a terminal device 220, the transmission information comprising: first waveform information to be used by the terminal device 220 for performing at least one uplink transmission, the first waveform information being comprised in a DCI message or a MAC CE message, second waveform information used by the terminal device 220 when performing a latest SRS transmission, and precoding information to be used by the terminal device 220 for performing at least one uplink transmission.

At block 1420, the network device 210 determines a TPMI or TPMI combination based on the transmission information.

In some embodiments, the first waveform information is one of the following: a first indication indicates whether a first waveform or a second waveform is enabled, a second indication indicates whether to switch a currently applied waveform, or information about a panel or a capability value set of the terminal device 220, the panel or the capability value set corresponding to a specific waveform.

In some embodiments, if the first waveform information and the precoding information are indicated by the DCI message, determining the TPMI or TPMI combination comprises one of: determining the TPMI or TPMI combination based on the first waveform information and the precoding information indicated by the DCI message, or determining the TPMI or TPMI combination based on the precoding information indicated by the DCI message and the second waveform information.

In some embodiments, if the first waveform information is indicated by the MAC CE message and the precoding information is indicated by the DCI message, determining the TPMI or TPMI combination comprises: determining the TPMI or TPMI combination based on the first waveform information and the precoding information until the first waveform information is used when performing the latest SRS.

In some embodiments, the first waveform information is indicated by: a SRS resource with a first pre-configured correspondence to a specific waveform, or a SRS resource set with a second pre-configured correspondence to a specific waveform.

In some embodiments, if the first waveform information indicates a waveform switch, the precoding information is not associated a TPMI index which is configured with different precoding matrices in a first codebook for a first waveform and a second codebook of a second waveform.

In some embodiments, the at least one uplink transmission is a single-layer transmission using 4 antenna ports and the TPMI index is one of the following values {12, 14, 17, 19, 20, 22, 25, 27}.

### Example Devices

In some example embodiments, the terminal device 220 deployed with a plurality of sets of antenna ports comprises circuitry configured to: receive a DCI message for scheduling at least one uplink transmission over at least two of the plurality of sets of antenna ports, the DCI message indicating: first information about SRS resources associated with the at least one uplink transmission, second information about the precoding information associated with the at least one uplink transmission; and third information indicating a transmission mode of the at least one uplink transmission; and transmit, based on the DCI message, the at least one uplink transmission over the at least two of the plurality of sets of antenna ports to a network.

In some embodiments, the plurality of sets of antenna ports comprise: a first set of antenna port corresponding to a first panel or a first capability value set of the terminal device 220, and a second set of antenna port corresponding to a second panel or a second capability value set of the terminal device 220. Further, the at least one uplink transmission is a CB-based PUSCH and performed via a plurality of TRPs.

In some embodiments, the circuitry is further configured to: receive a first SRS configuration, where the first SRS configuration indicates: a first SRS resource set associated with a first panel or a first capability value set of the terminal device 220, a second SRS resource set associated with a second panel or a second capability value set of the terminal device 220, and a third SRS resource set associated with both the first and second panels or both the first and second capability value sets of the terminal device 220.

In some embodiments, if the third information indicates that the at least one uplink transmission is a SDM repetition or a NCJT transmission, the first information comprises: a first SRI associated with the first SRS resource set, and a second SRI associated with the second SRS resource set; and the second information comprises: a first TPMI corresponding to the first SRI, and a second TPMI corresponding to the second SRI.

In some embodiments, if the third information indicates that the at least one uplink transmission is the SDM repetition, a number of layers associated with the first TPMI is the same with a number of layers associated with the second TPMI.

In some embodiments, if the third information indicates that the at least one uplink transmission is the NCJT transmission and the at least one uplink transmission is transmitted with one codeword, the first TPMI indicates a first precoder to be applied over at least one layer and the second TPMI indicates a second precoder to be applied over at least one further layer. Further, a total number of layers of the first and second precoders equals to a number of layers corresponds to the one codeword.

In some embodiments, if the third information indicates that the at least one uplink transmission is the NCJT transmission and the at least one uplink transmission is transmitted with a first codeword and a second codeword, the first TPMI indicates a first precoder to be applied over at least one layer, the number of the at least one layer corresponds to the first codeword, and the second TPMI indicates a second precoder to be applied over at least one further layer, the number of the at least one further layer corresponds to the second codeword.

In some embodiments, if the third information indicates that the at least one uplink transmission is a CJT transmission, the first information comprises: a third SRI associated with the third SRS resource set, and the second information comprises: a third TPMI corresponding to the third SRI.

In some embodiments, the circuitry is further configured to: receive a second SRS configuration indicating a third SRS resource set associated with both a first panel and a second panel or both a first capability value set and a second capability value set of the terminal device 220.

In some embodiments, the first information comprises: a third SRI associated with the third SRS resource set, and the second information comprises: at least one TPMI associated with at least one transmission precoder selected from an uplink codebook, the at least one transmission precoder having a corresponding number of ports corresponding to the at least one TPMI.

In some embodiments, if the third information indicates that the at least one uplink transmission is a SDM repetition or a NCJT transmission, the at least one TPMI comprises: a first TPMI corresponding to a first port group of the third SRS resource set, and a second TPMI corresponding to a second port group of the third SRS resource set.

In some embodiments, at least one of a number of the first port group and a number of the second port group are determined based on at least one of the following: port group information comprised in the DCI message, a first number of ports corresponding to the first TPMI, a second number of ports corresponding to the second TPMI, a number of ports of SRS resources comprised in the third SRS set, port group information comprised in the second SRS configuration, or capability information corresponding to a first and second control resource set pools of the terminal device 220.

In some embodiments, if the third information indicates that the at least one uplink transmission is a CJT transmission, the second information comprises: a third TPMI corresponding to the third SRI.

In some embodiments, the circuitry is further configured to: receive a third SRS configuration indicating: a first SRS resource set associated with a first panel or a first capability value set of the terminal device 220, and a second SRS resource set associated with a second panel or a second capability value set of the terminal device 220. In particular, resources comprised in the first and the second first SRS resource sets are supported to be used simultaneously.

In some embodiments, the first information comprises: a first SRI associated with the first SRS resource set, and a second SRI associated with the second SRS resource set; and the second information comprises: at least one TPMI associated with a transmission precoder selected from an uplink codebook, the transmission precoder having a number of ports corresponding to a sum of number of ports which associates with the first and second SRIs.

In some embodiments, if the third information indicates that the at least one uplink transmission is a CJT transmission, the at least one TPMI comprises one of the following: a fourth TPMI associated with the first SRI and second SRI, or a fifth TPMI and a sixth TPMI jointly associated with the first SRI and second SRI.

In some embodiments, the circuitry is further configured to: transmit, to the network device 210, transmission capability information over at least two of the plurality of sets of antenna ports, the transmission capability information comprising at least one of the following: a transmission mode associated with a simultaneous transmission with the plurality of sets of antenna ports, a hybrid beamforming type associated with a digital precoding manner and an analog beamforming manner, a first coherence type indicating a panel-level coherence capability, a second coherence type indicating a port-level coherence capability within a panel, a first full power mode indicating a panel-level full power capability, or a second full power mode indicating a port-level full power capability within a panel.

In some embodiments, the circuitry is further configured to: receive a SRS configuration generated based on the transmission capability information.

In some embodiments, the first coherence type, the second coherence type, the first full power mode and the second full power mode are associated with at least one of the following: the transmission mode, the hybrid beamforming type associated with a digital precoding manner and an analog beamforming manner.

In some embodiments, the first coherence type is one of the following: a first panel-level full power mode indicating that a full power is achieved regardless of a number of panels used for the at least one uplink transmission, a second panel-level full power mode indicating that the full power is enabled to be delivered when all panels of the terminal device 220 are used for the at least one uplink transmission, or a third panel-level full power mode indicating that the full power is enabled when all panels of the terminal device 220 are used for the at least one uplink transmission or at least one specific TPMI or TPMI combination is configured.

In some embodiments, if the first full power mode is the third panel-level full power mode, the transmission capability information further comprises information about the at least one specific TPMI or TPMI combination.

In some example embodiments, the terminal device 220 comprises circuitry configured to: transmit to full power transmission capability information a network, the full power transmission capability information indicating: a panel-level full power transmission capability, and a port-level full power transmission capability within a panel; receive a configuration for at least one uplink transmission from the network, the configuration indicating a TPMI or TPMI combination; and control a transmit power of the at least one uplink transmission based on the full power transmission capability information and the indicated TPMI or TPMI combination.

In some embodiments, In some embodiments, the circuitry is further configured to: scale the transmit power with: a first scaling factor calculated at least in part based on the panel-level full power transmission capability, and a second scaling factor calculated at least in part based on the port-level full power transmission capability within a panel.

In some embodiments, the first scaling factor is calculated based on at least one of the following: the panel-level full power transmission capability, a TPMI or TPMI combination configured for the at least one uplink transmission, a number of panels used for the at least one at least one uplink transmission, a number of activated panels of the terminal device 220, a number of panels corresponding to the TMPT or the TPMI combination, or a total number of panels of the terminal device 220.

In some embodiments, the second scaling factor is calculated based on at least one of the following: the port-level full power transmission capability, a TPMI or TPMI combination configured for the at least one uplink transmission, a number of ports used for the at least one uplink transmission within a panel, a number of activated ports within a panel, a number of ports corresponding to the TPMI or the TPMI combination, or a total number of ports within the panel.

In some example embodiments, the terminal device 220 comprises circuitry configured to: receive transmission information from a network device 210, the transmission information comprising: first waveform information to be used by the terminal device 220 for performing at least one uplink transmission, the first waveform information being comprised in a DCI message or a MAC CE message, second waveform information used by the terminal device 220 when performing a latest SRS transmission, and precoding information to be used by the terminal device 220 for performing the at least one uplink transmission; and determine a TPMI or TPMI combination based on the transmission information.

In some embodiments, the first waveform information is one of the following: a first indication indicates whether a first waveform or a second waveform is enabled, a second indication indicates whether to switch a currently applied waveform, or information about a panel or a capability value set of the terminal device 220, the panel or the capability value set corresponding to a specific waveform.

In some embodiments, if the first waveform information and the precoding information are indicated by the DCI message, the terminal device 220 determines the TPMI or TPMI combination comprises one of: determining the TPMI or TPMI combination based on the first waveform information and the precoding information indicated by the DCI message, or determining the TPMI or TPMI combination based on the precoding information indicated by the DCI message and the second waveform information.

In some embodiments, if the first waveform information is indicated by the MAC CE message and the precoding information is indicated by the DCI message, the terminal device 220 determines the TPMI or TPMI combination comprises: determining the TPMI or TPMI combination based on the first waveform information and the precoding information until the first waveform information is used when performing the latest SRS.

In some embodiments, the first waveform information is indicated by: a SRS resource with a first pre-configured correspondence to a specific waveform, or a SRS resource set with a second pre-configured correspondence to a specific waveform.

In some embodiments, if the first waveform information indicates a waveform switch, the precoding information is not associated a TPMI index which is configured with different precoding matrices in a first codebook for a first waveform and a second codebook of a second waveform.

In some embodiments, the at least one uplink transmission is a single-layer transmission using 4 antenna ports and the TPMI index is one of the following values {12, 14, 17, 19, 20, 22, 25, 27}.

In some example embodiments, the network device 210 comprises circuitry configured to: transmit, to a terminal device 220 deployed with a plurality of sets of antenna ports, a DCI message for scheduling at least one uplink transmission over at least two of the plurality of sets of antenna ports, the DCI message indicating: first information about SRS resources associated with the at least one uplink transmission, second information about the precoding information associated with the at least one uplink transmission; and third information indicating a transmission mode of the at least one uplink transmission; and receive, based on the DCI message, the at least one uplink transmission transmitted over the at least two of the plurality of sets of antenna ports from the terminal device 220.

In some embodiments, the plurality of sets of antenna ports comprise: a first set of antenna port corresponding to a first panel or a first capability value set of the terminal device 220, and a second set of antenna port corresponding to a second panel or a second capability value set of the terminal device 220. Further, the at least one uplink transmission is a CB-based PUSCH and performed via a plurality of TRPs.

In some embodiments, the circuitry is further configured to: transmit a first SRS configuration indicating: a first SRS resource set associated with a first panel or a first capability value set of the terminal device 220, a second SRS resource set associated with a second panel or a second capability value set of the terminal device 220, and a third SRS resource set associated with both the first and second panels or both the first and second capability value sets of the terminal device 220.

In some embodiments, if the third information indicates that the at least one uplink transmission is a SDM repetition or a NCJT transmission, the first information comprises: a first SRI associated with the first SRS resource set, and a second SRI associated with the second SRS resource set; and the second information comprises: a first TPMI corresponding to the first SRI, and a second TPMI corresponding to the second SRI.

In some embodiments, if the third information indicates that the at least one uplink transmission is the SDM repetition, a number of layers associated with the first TPMI is the same with a number of layers associated with the second TPMI.

In some embodiments, if the third information indicates that the at least one uplink transmission is the NCJT transmission and the at least one uplink transmission is transmitted with one codeword, the first TPMI indicates a first precoder to be applied over at least one layer and the second TPMI indicates a second precoder to be applied over at least one further layer. Further, a total number of layers of the first and second precoders equals to a number of layers corresponds to the one codeword.

In some embodiments, if the third information indicates that the at least one uplink transmission is the NCJT transmission and the at least one uplink transmission is transmitted with a first codeword and a second codeword, the first TPMI indicates a first precoder to be applied over at least one layer, the number of the at least one layer corresponds to the first codeword, and the second TPMI indicates a second precoder to be applied over at least one further layer, the number of the at least one further layer corresponds to the second codeword.

In some embodiments, if the third information indicates that the at least one uplink transmission is a CJT transmission, the first information comprises: a third SRI associated with the third SRS resource set, and the second information comprises: a third TPMI corresponding to the third SRI.

In some embodiments, the circuitry is further configured to: transmit a second SRS configuration indicating a third SRS resource set associated with both a first panel and a second panel or both a first capability value set and a second capability value set of the terminal device 220.

In some embodiments, the first information comprises: a third SRI associated with the third SRS resource set, and the second information comprises: at least one TPMI associated with at least one transmission precoder selected from an uplink codebook, the at least one transmission precoder having a corresponding number of ports corresponding to the at least one TPMI.

In some embodiments, if the third information indicates that the at least one uplink transmission is a SDM repetition or a NCJT transmission, the at least one TPMI comprises: a first TPMI corresponding to a first port group of the third SRS resource set, and a second TPMI corresponding to a second port group of the third SRS resource set.

In some embodiments, at least one of a number of the first port group and a number of the second port group are determined based on at least one of the following: port group information comprised in the DCI message, port group information comprised in the second SRS configuration, a first number of ports corresponding to the first TPMI, a second number of ports corresponding to the second TPMI, a number of ports of SRS resources comprised in the third SRS set, capability information corresponding to a first and second control resource set pools of the terminal device 220, a measured signal quality of each port of the terminal device 220.

In some embodiments, if the third information indicates that the at least one uplink transmission is a CJT transmission, the second information comprises: a third TPMI corresponding to the third SRI.

In some embodiments, In some embodiments, the circuitry is further configured to: transmit a third SRS configuration indicating: a first SRS resource set associated with a first panel or a first capability value set of the terminal device 220, and a second SRS resource set associated with a second panel or a second capability value set of the terminal device 220. Further, resources comprised in the first and the second first SRS resource sets are supported to be used simultaneously.

In some embodiments, the first information comprises: a first SRI associated with the first SRS resource set, and a second SRI associated with the second SRS resource set; and the second information comprises: at least one TPMI associated with a transmission precoder selected from an uplink codebook, the transmission precoder having a number of ports corresponding to a sum of number of ports which associates with the first and second SRIs.

In some embodiments, if the third information indicates that the at least one uplink transmission is a CJT transmission, the at least one TPMI comprises one of the following: a fourth TPMI associated with the first SRI and second SRI, or a fifth TPMI and a sixth TPMI jointly associated with the first SRI and second SRI.

In some embodiments, In some embodiments, the circuitry is further configured to: receive, from the terminal device 220, transmission capability information over at least two of the plurality of sets of antenna ports, the transmission capability information comprising at least one of the following: a transmission mode associated with a simultaneous transmission with the plurality of sets of antenna ports, a hybrid beamforming type associated with a digital precoding manner and an analog beamforming manner, a first coherence type indicating a panel-level coherence capability, a second coherence type indicating a port-level coherence capability within a panel, a first full power mode indicating a panel-level full power capability, or a second full power mode indicating a port-level full power capability within a panel.

In some embodiments, the circuitry is further configured to: generate a SRS configuration generated based on the transmission capability information and transmit the SRS configuration to the terminal device 220.

In some embodiments, the first coherence type, the second coherence type, the first full power mode and the second full power mode are associated with at least one of the following: the transmission mode, the hybrid beamforming type associated with a digital precoding manner and an analog beamforming manner.

In some embodiments, the first coherence type is one of the following: a first panel-level full power mode indicating that a full power is achieved regardless of a number of panels used for the at least one uplink transmission, a second panel-level full power mode indicating that the full power is enabled to be delivered when all panels of the terminal device 220 are used for the at least one uplink transmission, or a third panel-level full power mode indicating that the full power is enabled when all panels of the terminal device 220 are used for the at least one uplink transmission or at least one specific TPMI or TPMI combination is configured.

In some embodiments, if the first full power mode is the third panel-level full power mode, the transmission capability information further comprises information about the at least one specific TPMI or TPMI combination.

In some example embodiments, the network device 210 comprises circuitry configured to: receive transmission information from a terminal device 220, the transmission information comprising: first waveform information to be used by the terminal device 220 for performing at least one uplink transmission, the first waveform information being comprised in a DCI message or a MAC CE message, second waveform information used by the terminal device 220 when performing a latest SRS transmission, and precoding information to be used by the terminal device 220 for performing at least one uplink transmission; and determine a TPMI or TPMI combination based on the transmission information.

In some embodiments, the first waveform information is one of the following: a first indication indicates whether a first waveform or a second waveform is enabled, a second indication indicates whether to switch a currently applied waveform, or information about a panel or a capability value set of the terminal device 220, the panel or the capability value set corresponding to a specific waveform.

In some embodiments, if the first waveform information and the precoding information are indicated by the DCI message, determining the TPMI or TPMI combination comprises one of: determining the TPMI or TPMI combination based on the first waveform information and the precoding information indicated by the DCI message, or determining the TPMI or TPMI combination based on the precoding information indicated by the DCI message and the second waveform information.

In some embodiments, if the first waveform information is indicated by the MAC CE message and the precoding information is indicated by the DCI message, determining the TPMI or TPMI combination comprises: determining the TPMI or TPMI combination based on the first waveform information and the precoding information until the first waveform information is used when performing the latest SRS.

In some embodiments, the first waveform information is indicated by: a SRS resource with a first pre-configured correspondence to a specific waveform, or a SRS resource set with a second pre-configured correspondence to a specific waveform.

In some embodiments, if the first waveform information indicates a waveform switch, the precoding information is not associated a TPMI index which is configured with different precoding matrices in a first codebook for a first waveform and a second codebook of a second waveform.

In some embodiments, the at least one uplink transmission is a single-layer transmission using 4 antenna ports and the TPMI index is one of the following values {12, 14, 17, 19, 20, 22, 25, 27}.

FIG. 15 is a simplified block diagram of a device 1500 that is suitable for implementing embodiments of the present disclosure. The device 1500 can be considered as a further example implementation of the terminal 220 and the network devices 210-1 and 210-2 as shown in FIGS. 2A to 2C. Accordingly, the device 1500 can be implemented at or as at least a part of the terminal 220 and the network devices 210-1 and 210-2.

As shown, the device 1500 includes a processor 1510, a memory 1520 coupled to the processor 1510, a suitable transmitter (TX) and receiver (RX) 1540 coupled to the processor 1510, and a communication interface coupled to the TX/RX 1540. The memory 1510 stores at least a part of a program 1530. The TX/RX 1540 is for bidirectional communications. The TX/RX 1540 has at least one antenna to facilitate communication, though in practice an Access Node mentioned in this application may have several ones.

The communication interface may represent any interface that is necessary for communication with other network elements, such as X2 interface for bidirectional communications between eNBs, S1 interface for communication between a Mobility Management Entity (MME)/Serving Gateway (S-GW) and the eNB, Un interface for communication between the eNB and a relay node (RN), or Uu interface for communication between the eNB and a terminal device.

The program 1530 is assumed to include program instructions that, when executed by the associated processor 1510, enable the device 1500 to operate in accordance with the embodiments of the present disclosure, as discussed herein with reference to FIGS. 3-14. The embodiments herein may be implemented by computer software executable by the processor 1510 of the device 1500, or by hardware, or by a combination of software and hardware. The processor 1510 may be configured to implement various embodiments of the present disclosure. Furthermore, a combination of the processor 1510 and memory 1520 may form processing means 1550 adapted to implement various embodiments of the present disclosure.

The memory 1520 may be of any type suitable to the local technical network and may be implemented using any suitable data storage technology, such as a non-transitory computer readable storage medium, semiconductor-based memory devices, magnetic memory devices and systems, optical memory devices and systems, fixed memory and removable memory, as non-limiting examples. While only one memory 1520 is shown in the device 1500, there may be several physically distinct memory modules in the device 1500. The processor 1510 may be of any type suitable to the local technical network, and may include one or more of general purpose computers, special purpose computers, microprocessors, digital signal processors (DSPs) and processors based on multicore processor architecture, as non-limiting examples. The device 1500 may have multiple processors, such as an application specific integrated circuit chip that is slaved in time to a clock which synchronizes the main processor.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 3-14. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1.-63. (canceled)

64. A method, performed by a terminal device, the method comprising:
receiving downlink control information comprising a first sounding reference signal resource indicator (SRI), a second SRI, a first transmit precoding matrix indication (TPMI) and a second TPMI,
transmitting, to a network device, an uplink transmission based on the downlink control information,
wherein:
in a case where a first transmission mode of multiple panel simultaneous uplink transmission is configured via a radio resource control (RRC) message, the first TPMI is used to indicate a first precoder to be applied over at least one layer {0 . . . v1−1} of the uplink transmission corresponding to the first SRI, and the second TPMI is used to indicate a second precoder to be applied over at least one layer {v1 . . . v2+v1−1} of the uplink transmission corresponding to the second SRI, where v1 is a first number of layers indicated by the first TPMI and v2 is a second number of layers indicated by the second TPMI;
in a case where a second transmission mode of multiple panel simultaneous uplink transmission is configured via the RRC message, the first TPMI is used to indicate the first precoder to be applied over at least one layer {0 . . . v−1} of the uplink transmission corresponding to the first SRI, and the second TPMI is used to indicate the second precoder to be applied over at least one layer {0 . . . v−1} of the uplink transmission corresponding to the second SRI, where v is a number of layers of the uplink transmission corresponding to the first TPMI and the second TPMI respectively.

65. The method of claim 64, wherein
the first precoder indicated by the first TPMI and the second precoder indicated by the second TPMI correspond to different antenna ports.

66. The method of claim 64 wherein:
for the first transmission mode, different layers of the uplink transmission are separately transmitted to two transmit and receive points (TRPs);
for the second transmission mode, same layers of the uplink transmission are transmitted to the two TRPs.

67. The method of claim 63, wherein:
the first SRI and the first TPMI are associated with a first sounding reference signal (SRS) resource set, and the second SRI and the second TPMI are associated with a second SRS resource set.

68. The method of claim 63, wherein:
a parameter of maximum number of layers is configured corresponding to different transmission mode, and
a same value of the parameter is associated with the first TPMI and the second TPMI.

69. The method of claim 63, wherein
a total number of layers of the uplink transmission corresponds to one codeword.

70. The method of claim 63, wherein
transmission capability information associated with the first transmission mode or the second transmission mode is transmitted to the network device.

71. A method, performed by a network device, the method comprising:
transmitting downlink control information comprising a first sounding reference signal resource indicator (SRI), a second SRI, a first transmit precoding matrix indication (TPMI) and a second TPMI,
receiving, from a terminal device, an uplink transmission associated with the downlink control information,
wherein:
in a case where a first transmission mode of multiple panel simultaneous uplink transmission is configured via a radio resource control (RRC) message, the first TPMI is used to indicate a first precoder to be applied over at least one layer {0 . . . v1−1} of the uplink transmission corresponding to the first SRI, and the second TPMI is used to indicate a second precoder to be applied over at least one layer {v1 . . . v2+v1−1} of the uplink transmission corresponding to the second SRI, where v1 is a first number of layers indicated by the first TPMI and v2 is a second number of layers indicated by the second TPMI;
in a case where a second transmission mode of multiple panel simultaneous uplink transmission is configured via the RRC message, the first TPMI is used to indicate the first precoder to be applied over at least one layer {0 . . . v−1} of the uplink transmission corresponding to the first SRI, and the second TPMI is used to indicate the second precoder to be applied over at least one layer {0 . . . v−1} of the uplink transmission corresponding to the second SRI, where v is a number of layers of the uplink transmission corresponding to the first TPMI and the second TPMI respectively.

72. The method of claim 71, wherein
the first precoder indicated by the first TPMI and the second precoder indicated by the second TPMI correspond to different antenna ports.

73. The method of claim 71, wherein:
for the first transmission mode, different layers of the uplink transmission are separately transmitted to two transmit and receive points (TRPs);
for the second transmission mode, same layers of the uplink transmission are transmitted to the two TRPs.

74. The method of claim 71, wherein:
the first SRI and the first TPMI are associated with a first sounding reference signal (SRS) resource set, and the second SRI and the second TPMI are associated with a second SRS resource set.

75. The method of claim 71, wherein:
a parameter of maximum number of layers is configured corresponding to different transmission mode, and
a same value of the parameter is associated with the first TPMI and the second TPMI.

76. The method of claim 71, wherein
a total number of layers of the uplink transmission corresponds to one codeword.

77. The method of claim 71, wherein
transmission capability information associated with the first transmission mode or the second transmission mode is received from the terminal device.

78. A terminal device, comprising a processor configured to cause the terminal device to:
receive downlink control information comprising a first sounding reference signal resource indicator (SRI), a second SRI, a first transmit precoding matrix indication (TPMI) and a second TPMI,
transmit, to a network device, an uplink transmission based on the downlink control information,
wherein:
in a case where a first transmission mode of multiple panel simultaneous uplink transmission is configured via a radio resource control (RRC) message, the first TPMI is used to indicate a first precoder to be applied over at least one layer {0 . . . v1−1} of the uplink transmission corresponding to the first SRI, and the second TPMI is used to indicate a second precoder to be applied over at least one layer {v1 . . . v2+v1−1} of the uplink transmission corresponding to the second SRI, where v1 is a first number of layers indicated by the first TPMI and v2 is a second number of layers indicated by the second TPMI;
in a case where a second transmission mode of multiple panel simultaneous uplink transmission is configured via the RRC message, the first TPMI is used to indicate the first precoder to be applied over at least one layer {0 . . . v−1} of the uplink transmission corresponding to the first SRI, and the second TPMI is used to indicate the second precoder to be applied over at least one layer {0 . . . v−1} of the uplink transmission corresponding to the second SRI, where v is a number of layers of the uplink transmission corresponding to the first TPMI and the second TPMI respectively.

79. The terminal device of claim 78, wherein
the first precoder indicated by the first TPMI and the second precoder indicated by the second TPMI correspond to different antenna ports.

80. The terminal device of claim 78, wherein:
for the first transmission mode, different layers of the uplink transmission are separately transmitted to two transmit and receive points (TRPs);
for the second transmission mode, same layers of the uplink transmission are transmitted to the two TRPs.

81. The terminal device of claim 78, wherein:
the first SRI and the first TPMI are associated with a first sounding reference signal (SRS) resource set, and the second SRI and the second TPMI are associated with a second SRS resource set.

82. The terminal device of claim 78, wherein:
a parameter of maximum number of layers is configured corresponding to different transmission mode, and
a same value of the parameter is associated with the first TPMI and the second TPMI.

83. The terminal device of claim 78, wherein
a total number of layers of the uplink transmission corresponds to one codeword.
